(19) United States
(12) Patent Application Publication
(10) Pub. No.: US 2023/0408874 A1
(43) Pub. Date: Dec. 21, 2023

(54) DISPLAY DEVICE

(71) Applicant: Japan Display Inc., Tokyo (JP)

(72) Inventors: Shunichi KIMURA, Tokyo (JP); Toshiharu MATSUSHIMA, Tokyo (JP)

(73) Assignee: Japan Display Inc., Tokyo (JP)

(21) Appl. No.: 18/461,523

(22) Filed: Sep. 6, 2023

Related U.S. Application Data
(63) Continuation of application No. 17/749,142, filed on May 20, 2022.

(30) Foreign Application Priority Data
May 24, 2021 (JP) 2021-086760

(51) Int. Cl. G02F 1/1343; G02F 1/1335

(52) U.S. Cl. CPC G02F 1/134309; G02F 1/133512

(57) ABSTRACT

According to one embodiment, in a display device, a first pixel electrode and a second pixel electrode overlap with a first electrode which includes a first branch portion that is exposed from between the first pixel electrode and the second pixel electrode, a second electrode includes a first trunk portion, a second branch portion, and a second trunk portion, the second branch portion overlaps with the first pixel electrode, a light-shielding layer includes a first opening portion, a second opening portion, and a light-shielding portion located between the first and second opening portions, the first opening portion overlaps with the second branch portion, and the light-shielding portion overlaps with the first branch portion.

### CROSS-REFERENCE TO RELATED APPLICATIONS

This application is a continuation of U.S. patent application Ser. No. 17/749,142, filed May 20, 2022, which is based upon and claims the benefit of priority from Japanese Patent Application No. 2021-086760, filed May 24, 2021, the entire contents of each are incorporated herein by reference.

### FIELD

Embodiments described herein relate generally to a display device.

### BACKGROUND

This display device having a high-speed response mode is considered to have a configuration in which a pixel electrode and a common electrode are disposed in different layers, a slit is provided in an electrode on the side close to a liquid crystal layer, and liquid crystal molecules near both sides of the slit in the width direction are rotated in opposite directions to each other. This display device adopts a system clearly different from the conventional Fringe Field Switching (FFS) mode, and can achieve a higher response speed than in the FFS mode. When this display device is made higher in definition, an interval between electrodes adjacent to each other across the slit is narrowed, which causes a possibility of a short circuit or the like.

### BRIEF DESCRIPTION OF THE DRAWINGS

FIG. 1 is a perspective view showing a schematic configuration of a liquid crystal display device according to a first embodiment.

FIG. 2 is a view showing an example of a schematic equivalent circuit of the display device.

FIG. 3 is a cross-sectional view schematically showing an example of the display device according to the first embodiment.

FIG. 4 is a cross-sectional view schematically showing an example of the display device according to the first embodiment.

FIG. 5 is a plan view schematically showing an example of an initial orientation state of liquid crystal molecules contained in a liquid crystal layer in an off state in which no voltage is applied to a common electrode and a pixel electrode related to a high-speed response mode.

FIG. 6 is a plan view schematically showing an example of an orientation state of liquid crystal molecules in an on state in which a voltage is applied between the common electrode and the pixel electrode in FIG. 5.

FIG. 7 is a plan view schematically showing an example of an initial orientation state of liquid crystal molecules contained in the liquid crystal layer in the off state in which no voltage is applied to the common electrode and the pixel electrode related to the high-speed response mode.

FIG. 8 is a plan view schematically showing an example of an orientation state of liquid crystal molecules in the on state in which a voltage is applied between the common electrode and the pixel electrode in FIG. 7.

FIG. 9 is a plan view schematically showing a configuration example of a first substrate according to the first embodiment.

FIG. 10 is a plan view schematically showing a configuration example of a second substrate according to the first embodiment.

FIG. 11 is a plan view schematically showing a configuration example of a first substrate according to a display device of Modified Example 1.

FIG. 12 is a plan view schematically showing a configuration example of a second substrate according to Modified Example 1.

FIG. 13 is a plan view schematically showing a configuration example of a first substrate according to a display device of Modified Example 2.

FIG. 14 is a schematic view schematically showing an example of a sub-pixel.

FIG. 15 is a plan view schematically showing a configuration example of a common electrode in a non-display area according to Modified Example 2.

FIG. 16 is a plan view schematically showing a configuration example of a second substrate according to Modified Example 2.

FIG. 17 is a plan view schematically showing a configuration example of the second substrate according to Modified Example 2.

FIG. 18 is a cross-sectional view schematically showing a configuration example of the display device cut along B-B in FIG. 16.

FIG. 19 is a plan view schematically showing a configuration example of a first substrate according to a display device of Modified Example 3.

FIG. 20 is a plan view schematically showing a configuration example of a first substrate according to a display device of Modified Example 4.

FIG. 21 is a plan view schematically showing a configuration example of a second substrate according to Modified Example 4.

FIG. 22 is a cross-sectional view schematically showing a configuration example of the display device cut along C-C in FIG. 21.

FIG. 23 is a plan view schematically showing a configuration example of a first substrate according to a display device of Modified Example 5.

FIG. 24 is a plan view schematically showing a configuration example of a second substrate according to Modified Example 5.

FIG. 25 is a cross-sectional view schematically showing a configuration example of the display device cut along D-D in FIG. 24.

FIG. 26 is a plan view schematically showing a configuration example of a first substrate according to a display device of Modified Example 6.

FIG. 27 is a plan view schematically showing a configuration example of a second substrate according to Modified Example 6.

FIG. 28 is a cross-sectional view schematically showing a configuration example of the display device cut along E-E in FIG. 27.

FIG. 29 is a cross-sectional view schematically showing a configuration example of the display device cut along F-F in FIG. 27.

FIG. 30 is a cross-sectional view schematically showing a configuration example of the display device cut along H-H in FIG. 27.

FIG. 31 is a plan view schematically showing a configuration example of a first substrate according to a display device of Modified Example 7.

FIG. 32 is a cross-sectional view schematically showing a configuration example of the display device cut along E-E in FIG. 31.

FIG. 33 is a cross-sectional view schematically showing a configuration example of the display device cut along F-F in FIG. 31.

### DETAILED DESCRIPTION

In general, according to one embodiment, a display device comprises
a first substrate;
a second substrate opposed to the first substrate; and
a liquid crystal layer located between the first substrate and the second substrate, wherein
the first substrate includes a first electrode, a first pixel electrode, a second pixel electrode disposed at an interval in a first direction from the first pixel electrode, and a second electrode,
the second substrate includes a light-shielding layer,
the first pixel electrode and the second pixel electrode overlap with the first electrode,
the first electrode includes a first branch portion that is exposed from between the first pixel electrode and the second pixel electrode and extends in a second direction intersecting the first direction,
the second electrode includes a first trunk portion extending in the first direction, a second branch portion extending in the second direction from the first trunk portion, and a second trunk portion disposed at an interval in the second direction from the first trunk portion and extending in the first direction,
the second branch portion overlaps with the first pixel electrode,
the light-shielding layer includes a first opening portion, a second opening portion provided at an interval in the first direction from the first opening portion, and a light-shielding portion located between the first opening portion and the second opening portion,
the first opening portion overlaps with the second branch portion, and
the light-shielding portion overlaps with the first branch portion.

According to another embodiment, a display device comprises
a first substrate;
a second substrate opposed to the first substrate; and
a liquid crystal layer located between the first substrate and the second substrate, wherein
the first substrate includes a first electrode, a first pixel electrode, a second pixel electrode disposed at an interval in a first direction from the first pixel electrode, and a second electrode,
the second substrate includes a light-shielding layer,
the first pixel electrode and the second pixel electrode overlap with the first electrode,
the first electrode includes a first branch portion that is exposed from between the first pixel electrode and the second pixel electrode and extends in a second direction intersecting the first direction,
the second electrode includes a second branch portion extending in the second direction,
the second branch portion overlaps with the first pixel electrode,
the light-shielding layer includes a first opening portion, a second opening portion provided at an interval in the first direction from the first opening portion, and a light-shielding portion located between the first opening portion and the second opening portion,
the first opening portion overlaps with the second branch portion, and
the light-shielding portion overlaps with the first branch portion.

According to another embodiment, a display device comprises
a first substrate;
a second substrate opposed to the first substrate; and
a liquid crystal layer located between the first substrate and the second substrate, wherein
the first substrate includes a first electrode, a first pixel electrode, and a second electrode,
the second substrate includes a light-shielding layer,
the first pixel electrode overlaps with the first electrode,
the first pixel electrode includes a first portion, a second portion disposed separated in the first direction from the first portion, and a slit extending between the first portion and the second portion in a second direction intersecting the first direction,
the first electrode includes a first branch portion that is exposed from the slit and extends in the second direction,
the second electrode includes a first trunk portion extending in the first direction, a second branch portion extending in the second direction from the first trunk portion, a third branch portion disposed at an interval in the first direction from the second branch portion and extending in the second direction from the first trunk portion, and a second trunk portion disposed at an interval in the second direction from the first trunk portion and extending in the first direction,
the second branch portion overlaps with the first portion,
the third branch portion overlaps with the second portion,
the light-shielding layer includes an opening portion, and
the opening portion overlaps with the first branch portion, the second branch portion, and the third branch portion.

An object of the present embodiment is to provide a display device that can be easily manufactured and can display a high-quality image.

Embodiments will be described hereinafter with reference to the accompanying drawings. The disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

In the embodiment, a display device is disclosed as an example of an electronic device. This display device can be used for various devices, for example, such as a virtual reality (VR) viewer, a smartphone, a tablet terminal, a cellular telephone terminal, a personal computer, a television receiver, a vehicle-mounted device, a game console, and a wearable terminal.

### First Embodiment

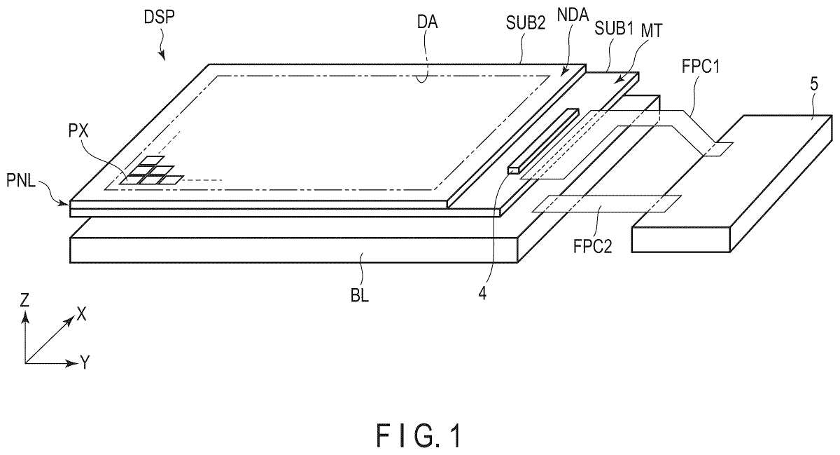

FIG. 1 is a perspective view schematically showing an example of a configuration of a display device DSP according to the first embodiment. For example, a first direction X, a second direction Y and a third direction Z are orthogonal to each other, but they may intersect at an angle other than 90 degrees. The first direction X and the second direction Y correspond to the directions parallel to a main surface of a substrate that constitutes the liquid display device DSP, which will be referred to simply as a display device, hereinafter). The third direction Z is equivalent to a thickness direction of the display device DSP. In the following descriptions, a direction from a first substrate SUB1 towards a second substrate SUB2 is referred to as “upward” (or simply, above) and a direction from the second substrate SUB2 towards the first substrate SUB1 is referred to as “downward” (or simply, below). With such expressions “a second member above a first member” and “a second member below a first member”, the second member may be in contact with the first member or may be remote from the first member. Further, it is assumed that there is an observation position to observe the semiconductor substrate on a tip side of an arrow in a third direction Z, and viewing from this observation position toward the X-Y plane defined by the first direction X and the second direction Y is referred to as a planar view.

In addition, “the width (or length) of a predetermined substance, object, space, or area in the first direction X” may be referred to as a “lateral width”, and “the width (or length) of a predetermined substance, object, space, or area in the second direction Y” may be referred to as a “longitudinal width”.

The display device DSP includes a display panel PNL, an illumination device BL opposed to the display panel PNL, a driver integrated circuit (IC) 4 that drives the display panel PNL, a control module 5 that controls operations of the display panel PNL and the illumination device BL, and flexible printed circuits FPC1 and FPC2 that transmit control signals to the display panel PNL and the illumination device BL. In the example shown in FIG. 1, the short side of the display device DSP extends along the first direction X, and the long side of the display device DSP extends along the second direction Y. Incidentally, the long side of the display device DSP may extend along the first direction X, and the short side of the display device DSP may extend along the second direction Y.

The display panel PNL includes the first substrate SUB1 and the second substrate SUB2 opposed to each other, and a display function layer (in the present embodiment, a liquid crystal layer LC to be described later) held between the substrates SUB1 and SUB2. The display panel PNL includes a display area DA and a non-display area NDA. The display area DA is an area for displaying an image. The display area DA is located substantially at the center of an area where the first substrate SUB1 and the second substrate SUB2 are opposed to each other. The non-display area NDA is an area where no image is displayed and is located outside the display area DA. The display panel PNL includes, for example, a plurality of pixels PX arranged in a matrix on the X-Y plane in the display area DA.

The driver IC 4 is located in the non-display area NDA. In the example shown in FIG. 1, the driver IC 4 is mounted on a mounting portion MT of the first substrate SUB1 extending outward from one substrate edge (alternatively, also referred to as a substrate end portion) of the second substrate SUB2. Incidentally, the driver IC 4 may be provided on the flexible printed circuit FPC1.

In the example shown in FIG. 1, the flexible printed circuit FPC1 electrically connects the display panel PNL to the control module 5. For example, the flexible printed circuit FPC1 is electrically connected to a terminal (not shown) provided in the mounting portion MT of the first substrate SUB1 and to a terminal (not shown) provided in the control module 5.

In the example shown in FIG. 1, the flexible printed circuit FPC2 electrically connects the illumination device BL to the control module 5. For example, the flexible printed circuit FPC2 is electrically connected to a terminal (not shown) provided in the illumination device BL and to a not-shown terminal provided in the control module 5.

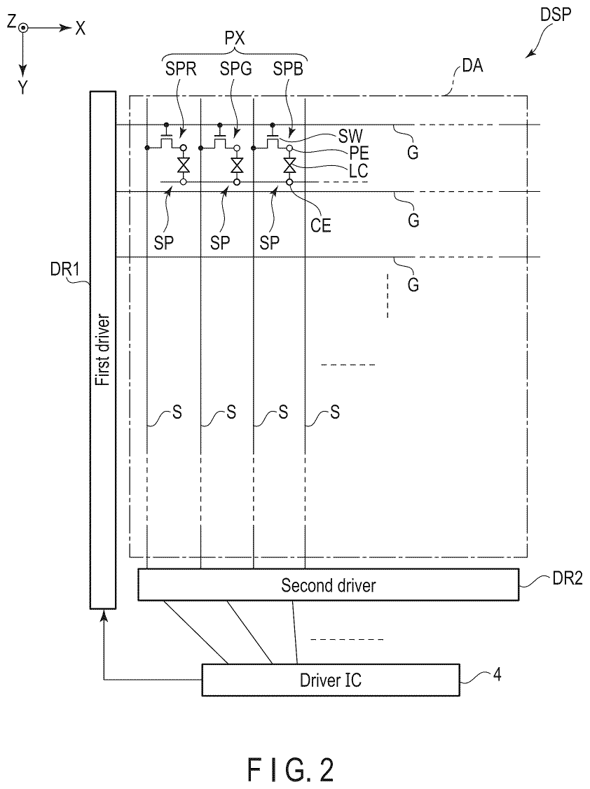

FIG. 2 is a view showing an example of a schematic equivalent circuit of the display device DSP. The display device DSP includes a first driver DR1, a second driver DR2, a plurality of scanning lines (scanning signal lines) G connected to the first driver DR1, and a plurality of signal lines S connected to the second driver DR2. The scanning lines G extend in the first direction X in the display area DA and are arranged at intervals in the second direction Y. The signal lines S extend in the second direction Y in the display area DA and are arranged at intervals in the first direction X, and the signal lines S intersects the scanning lines G.

Each of the pixels PX includes a plurality of sub-pixels SP. In the present embodiment, one pixel PX is assumed to include one sub-pixel SPR, one sub-pixel SPG, and one sub-pixel SPB that display red, green, and blue, respectively. However, the pixel PX may further include a sub-pixel SP that displays white, or may include a plurality of sub-pixels SP corresponding to the same color. Incidentally, the sub-pixel SP may be simply referred to as the pixel SP.

In FIG. 2, the sub-pixel SP corresponds to an area partitioned by two scanning lines G adjacent in the first direction X and two signal lines S adjacent in the second direction Y. Each of the sub-pixels SP includes a switching element SW, a pixel electrode PE, a common electrode CE opposed to the pixel electrode PE, the liquid crystal layer LC, and others. The common electrode CE is formed over the plurality of sub-pixels SP. The common electrode CE is applied with a common electric potential. The switching element SW is constituted of, for example, a thin-film transistor (TFT), and is connected to the scanning line G, the signal line S, and the pixel electrode PE. More specifically, the switching element SW includes a gate electrode, a source electrode, a drain electrode, a semiconductor layer, and others. For example, the gate electrode is electrically connected to the scanning line G, the source electrode is electrically connected to the signal line S, and the drain electrode is electrically connected to the pixel electrode PE and the semiconductor layer.

The scanning line G is connected to the switching element SW in each of the pixels SP arranged in the first direction X. The signal line S is connected to the switching element SW in each of the pixels SP arranged in the second direction Y. Each of the pixel electrodes PE is opposed to the common electrode CE, and drives the liquid crystal layer LC by an electric field generated between the pixel electrode PE and the common electrode CE. For example, a storage capacitance is formed between the common electrode CE and the pixel electrode PE.

The first driver DR1 sequentially supplies a scanning signal to each of the scanning lines G. The second driver DR2 selectively supplies a video signal to each of the signal lines S. When the scanning signal is supplied to the scanning line G corresponding to a certain switching element SW and the signal line S connected to this switching element SW is supplied with the video signal, a pixel potential corresponding to the video signal is applied to the pixel electrode PE. At this time, the electric field generated between the pixel electrode PE and the common electrode CE causes orientation of liquid crystal molecules of the liquid crystal layer LC to change from an initial orientation state of no voltage being applied. This action causes an image to be displayed in the display area DA.

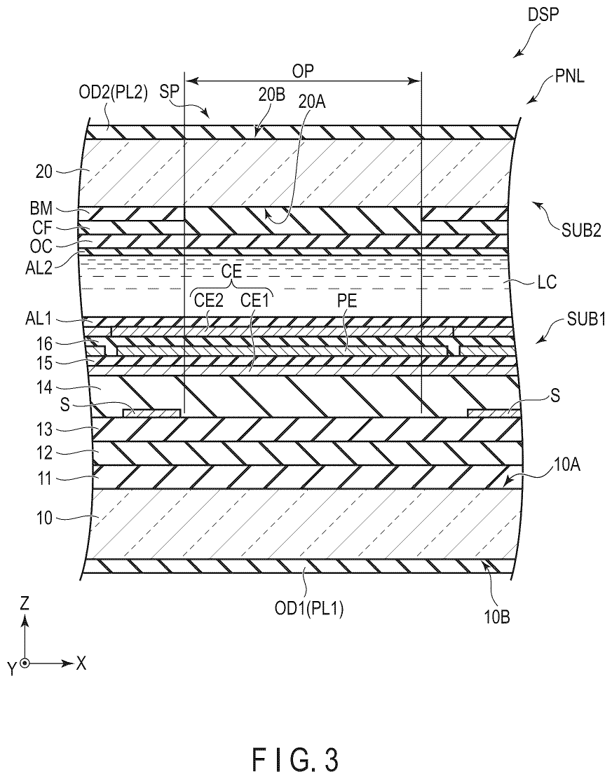

FIG. 3 is a cross-sectional view schematically showing an example of the display device DSP according to the present embodiment. FIG. 3 shows a schematic cross section of one sub-pixel SP. Incidentally, FIG. 3 shows only main portions of the display device DSP.

The first substrate SUB1 includes an insulating substrate 10, insulating layers (or dielectric layers) 11, 12, 13, 14, 15, and 16, the signal line S, the common electrode CE (common electrode CE1 and common electrode CE2), the pixel electrode PE, an orientation film AL1, and others. An optical element OD1 including a polarizer (polarizing plate) PL1 is provided under the insulating substrate 10. Incidentally, the first substrate SUB1 may include a layer, a film, and an electrode other than the insulating substrate 10, the insulating layers 11 to 16, the signal line S, the common electrode CE, the pixel electrode PE, and the orientation film AL1. In addition, the first substrate SUB1 may not include at least one of a layer, a film, and an electrode among the insulating substrate 10, the insulating layers 11 to 16, the signal line S, the common electrode CE, the pixel electrode PE, and the orientation film AL1.

The insulating substrate 10 is transparent, and is made of, for example, glass such as borosilicate glass, but may be made of resin such as plastic. The insulating substrate 10 includes a main surface 10A opposed to the second substrate SUB2 and an opposite surface 10B on the opposite side to the main surface 10A.

The insulating layers 11 to 16 are all transparent. The insulating layers 11, 12, 13, 15, and 16 are inorganic insulating layers, and are made of, for example, silicon nitride or silicon oxide. The insulating layer 14 is an organic insulating layer, and is made of, for example, resin such as acrylic resin. The insulating layer 11 is located on the insulating substrate 10 and is in contact with the main surface of the insulating substrate 10. The insulating layer 12 is located on the insulating layer 11 and is in contact with the insulating layer 11. The insulating layer 13 is located on the insulating layer 12 and is in contact with the insulating layer 12. The signal line S is located on the insulating layer 13 and is in contact with the insulating layer 13. In other words, the signal line S is located between the insulating layers 13 and 14. In the example shown in FIG. 3, the two signal lines S are located on the insulating layer 13 and disposed at an interval in the first direction X. The insulating layer 14 is located on the insulating layer 13 and the signal lines S, and is in contact with the insulating layer 13 and the signal lines S.

The common electrode CE1 is located on the insulating layer 14 and is in contact with the insulating layer 14. In other words, the common electrode CE1 is located between the insulating layers 14 and 15. The common electrode CE1 is disposed in a solid form. The common electrode CE1 overlaps with the signal lines S. The common electrode CE1 extends over the plurality of pixel electrodes PE. For example, the common electrode CE1 is made of transparent conductive material such as indium tin oxide (ITO), indium zinc oxide (IZO), or indium gallium oxide (IGO). Incidentally, the common electrode CE1 only needs to be transparent in a part that overlaps with an area contributing to display, and other parts may be made of material that is not transparent. The insulating layer is located on the common electrode CE1 and covers the common electrode CE1.

The pixel electrode PE has, for example, an electric potential different from that of the common electrode CE1. The pixel electrode PE is made of transparent conductive material. For example, the pixel electrode PE may be made of the same material as the common electrode CE1. Incidentally, the terms “the same”, “identical”, and “equivalent” include the meaning that physical quantities, materials, configurations (structures), and the like of a plurality of target objects, spaces, areas, and the like are completely the same, as well as being slightly different to the extent that they can be regarded as being substantially the same. The pixel electrode PE is located on the insulating layer 15 and is in contact with the insulating layer 15. In other words, the pixel electrode PE is located between the insulating layers 15 and 16. The pixel electrode PE overlaps with the common electrode CE1. Incidentally, the pixel electrode PE only needs to be transparent in a part that overlaps with an area contributing to display, and other parts may be made of material that is not transparent. The insulating layer 16 is located on the insulating layer 15 and the pixel electrode PE, and covers the insulating layer 15 and the pixel electrode PE.

The common electrode CE2 is located on the insulating layer 16 and is in contact with the insulating layer 16. The common electrode CE2 overlaps with the pixel electrode PE and the common electrode CE1. The common electrode CE2 is made of transparent conductive material, and is formed of, for example, the same material as the common electrode CE1. In the example shown in FIG. 3, the common electrode CE2 extends in the first direction X. The two common electrodes CE2 adjacent to each other in the first direction X are in contact with each other. Incidentally, the two common electrodes CE2 adjacent to each other in the first direction X may be disposed at an interval in the first direction X. The common electrode CE1 and the common electrode CE2 have the same electric potential, and for example, are applied with the same common electric potential. Although not shown, the common electrode CE1 and the common electrode CE2 are electrically connected in, for example, the non-display area NDA. Incidentally, the common electrode CE2 only needs to be transparent in a part that overlaps with an area contributing to display, and other portions may be made of material that is not transparent.

The orientation film AL1 covers the common electrode CE2. Incidentally, the orientation film AL1 may cover the insulating layer 16 and the common electrode CE2. The orientation film AL1 is, for example, a polyimide film. Incidentally, in the first substrate SUB1, a layer other than the layers described above may be located between the layers.

The liquid crystal layer LC is located on the first substrate SUB1. The liquid crystal layer LC may be a positive type layer having positive dielectric anisotropy or may be a negative type layer having negative dielectric anisotropy.

The second substrate SUB2 is located on the liquid crystal layer LC. The second substrate SUB2 includes an insulating substrate 20, a light-shielding layer BM, a color filter CF, an overcoat layer OC, an orientation film AL2, and others. Incidentally, at least one of the light-shielding layer BM and the color filter CF may be provided in the first substrate SUB1. An optical element OD2 including a polarizer PL2 is provided on the insulating substrate 20. The absorption axis of the polarizer PL1 and the absorption axis of the polarizer PL2 are set to be orthogonal to each other in planar view. Incidentally, the second substrate SUB2 may include a layer, a film, and an electrode other than the insulating substrate 20, the light-shielding layer BM, the color filter CF, the overcoat layer OC, and the orientation film AL2. In addition, the second substrate SUB2 may not include at least one of the layer, the film, and the electrode among the insulating substrate 20, the light-shielding layer BM, the color filter CF, the overcoat layer OC, and the orientation film AL2.

The insulating substrate 20 is transparent, and is made of, for example, glass such as borosilicate glass, but may be made of resin such as plastic. The insulating substrate 20 includes an opposite surface opposed to the first substrate SUB1 and a main surface 20B on the opposite side to the opposite surface 20A.

The light-shielding layer BM is located below the insulating substrate 20 and is in contact with the opposite surface 20A of the insulating substrate 20. The light-shielding layer BM is located directly above the signal lines S. The light-shielding layer BM is disposed at the boundary of the sub-pixel SP. The light-shielding layer BM disposed in this manner forms a pixel opening portion (hereinafter, may be simply referred to as an opening portion) OP that substantially contributes to image display. The opening portion OP is opposed to the pixel electrode PE.

The color filter CF is located below the insulating substrate 20 and the light-shielding layer BM, and covers the insulating substrate 20 and the light-shielding layer BM. The color filter CF is opposed to the pixel electrode PE. The color filter CF covers the opposite surface 20A of the insulating substrate 20 and the light-shielding layer BM. The color filter CF includes a red color filter, a green color filter, a blue color filter, and others. In addition, the color filter CF may include four or more color filters. In the sub-pixel SP displaying white, a white color filter may be disposed, an uncolored resin material may be disposed, or the overcoat layer OC may be disposed without disposing a color filter.

The overcoat layer OC is a transparent organic insulating layer, and is made of, for example, resin such as acrylic resin. The overcoat layer OC is located below the color filter CF and covers the color filter CF. The overcoat layer OC planarizes the surface of the color filter CF.

The orientation film AL2 is located below the overcoat layer OC and covers the overcoat layer OC. The orientation film AL2 is, for example, an optical orientation polyimide film. Incidentally, in the second substrate SUB2, a layer other than the layers described above may be located between the layers.

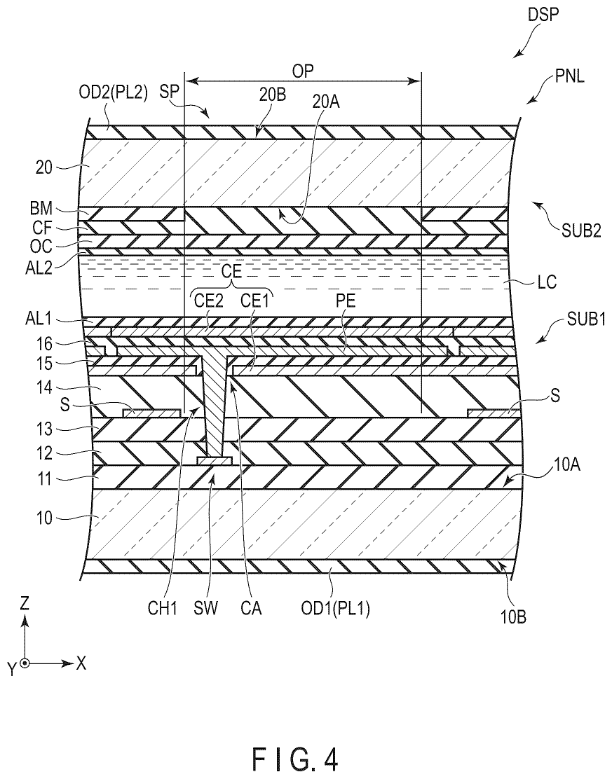

FIG. 4 is a cross-sectional view schematically showing an example of the display device DSP according to the present embodiment. Here, a configuration different from the configuration shown in FIG. 3 is mainly described. Incidentally, FIG. 4 shows only a configuration necessary for description.

The first substrate SUB1 includes a contact hole CH1, the switching element SW, and others. The contact hole CH1 is formed by penetrating the insulating layers 12, 13, 14, and 15, and passes a through hole CA formed in the common electrode CE1. The switching element SW is provided on the insulating layer 11. For example, the switching element SW is located on the insulating layer 11 and is in contact with the insulating layer 11. In other words, the switching element SW is located between the insulating layer 11 and the insulating layer 12. The switching element SW is electrically connected to the pixel electrode PE through the contact hole CH1. In FIG. 4, the switching element SW is shown in a simplified manner. In practice, the insulating layer 12 includes a plurality of layers, and the switching element SW includes semiconductor layers and various electrodes formed on these layers.

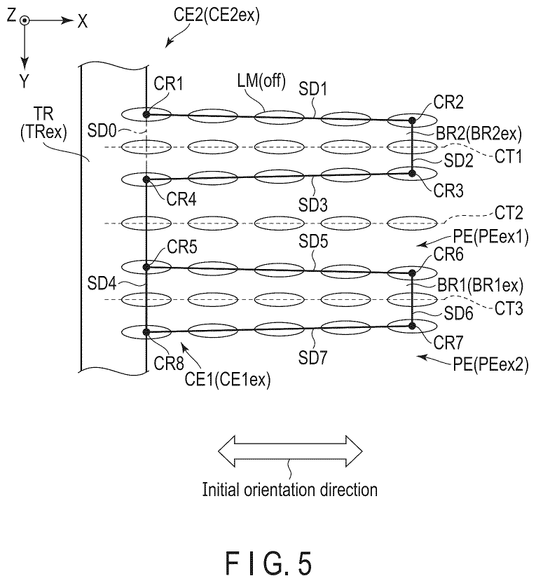

The operation principle of the high-speed response mode is described with reference to FIGS. 5, 6, 7, and 8.

FIG. 5 is a plan view schematically showing an example of an initial orientation state of liquid crystal molecules LM contained in the liquid crystal layer LC in the off state in which no voltage is applied to the common electrode CE and the pixel electrode PE related to the high-speed response mode.

The pixel electrode PE (PEex1, PEex2) overlaps with the common electrode CE1 (CE1ex). In the example shown in FIG. 5, the pixel electrode PE includes a pixel electrode PEex1 and a pixel electrode PEex2. The pixel electrodes PEex1 and PEex2 overlap with the common electrode CE1ex. The pixel electrodes PEex1 and PEex2 are disposed at intervals on the distal part side of the arrow in the second direction Y. The sizes of the pixel electrodes PEex1 and PEex2 are the same. Incidentally, the sizes of the pixel electrodes PEex1 and PEex2 may be different from each other.

The common electrode CE2 (CE2ex) has a trunk portion (or a shaft portion) TR (TRex) and a branch portion BR2 (BR2ex). Incidentally, the common electrode CE2 may not include the trunk portion TR. The common electrode CE2 (CE2ex) overlaps with the pixel electrodes (PEex1, PEex2) and the common electrode CE1 (CE1ex).

In the example shown in FIG. 5, the common electrode CE2 includes a common electrode CE2ex. The common electrode CE2ex has a trunk portion TRex and a branch portion BR2ex. The trunk portion TRex extends in the second direction Y. The trunk portion TRex overlaps with, for example, the pixel electrodes PEex1 and PEex2 and the common electrode CE1ex. The branch portion BR2ex is connected to the trunk portion TRex. The branch portion BR2ex extends from the trunk portion TRex to the distal part side of the arrow in the first direction X. The branch portion BR2ex overlaps with the pixel electrode PEex1 and common electrode CE1ex.

The branch portion BR2ex includes a corner portion CR1 at the proximal part connected to the trunk portion TRex, a corner portion CR2 at the distal part on the distal part side of the arrow in the first direction X, a corner portion CR3 located on the opposite side to the corner portion CR2 in the second direction Y at the distal part on the distal part side of the arrow in the first direction X, and a corner portion CR4 located on the opposite side to the corner portion CR1 in the second direction Y at the proximal part connected to the trunk portion TRex. The branch portion BR2ex includes a bottom side SD0 connecting the corner portions CR1 and CR4, a side SD1 connecting the corner portions CR1 and CR2, a top side SD2 connecting the corner portions CR2 and CR3, and a side SD3 connecting the corner portions CR3 and CR4. The bottom side SD0 and the top side SD2 are opposed to each other in the first direction X. The sides SD1 and SD3 are opposed to each other in the second direction Y. The side SD1 is inclined with respect to the trunk portion TRex. Incidentally, the side SD1 may not be inclined with respect to the trunk portion TRex. In other words, the side SD1 may be orthogonal to the trunk portion TRex. The side SD3 is inclined with respect to the trunk portion TRex. Incidentally, the side SD3 may not be inclined with respect to the trunk portion TRex. In other words, the side SD3 may be orthogonal to the trunk portion TRex. The sides SD1 and SD3 are not parallel to each other. Incidentally, the sides SD1 and SD3 may be parallel to each other. The branch portion BR2ex is formed in a trapezoidal shape having the bottom side SD0 as a lower base and the top side SD2 as an upper base in planar view. The shape of the branch portion BR2ex may be formed in a shape other than the trapezoidal shape, for example, a quadrangular shape (a square shape or a rectangular shape).

The common electrode CE1 (CE1ex) overlaps with the common electrode CE2 (CE2ex) and the pixel electrodes PE (PEex1 and PEex2). In the example shown in FIG. 5, the common electrode CE1 includes the common electrode CE1ex. The common electrode CE1ex overlaps with the common electrode CE2ex, the pixel electrode PEex1, and the pixel electrode PEex2. The common electrode CE1ex is exposed from (a gap or a slit) between the two pixel electrodes PEex1 and PEex2 adjacent to each other in the second direction Y. Hereinafter, the common electrode CE1 exposed from between the two pixel electrodes PE adjacent to each other may be referred to as a branch portion BR1. The common electrode CE1ex includes a branch portion BR1ex. The branch portion BR1ex corresponds to a portion of the common electrode CE1ex exposed from between the two pixel electrodes PEex1 and PEex2 adjacent to each other in the second direction Y. The branch portion BR1ex extends from the trunk portion TRex in the first direction X. The lateral width of the branch portion BR1ex is the same as the lateral width of the branch portion BR2. Incidentally, the lateral width of the branch portion BR1ex may be different from the lateral width of the branch portion BR2.

The branch portion BR1ex includes a corner portion CR5 at the proximal part intersecting the trunk portion TRex in planar view, a corner portion CR6 at the distal part on the distal part side of the arrow in the first direction X, a corner portion CR7 located on the opposite side to the corner portion CR6 in the second direction Y at the distal part on the distal part side of the arrow in the first direction X, and a corner portion CR8 located on the opposite side to the corner portion CR5 in the second direction Y at the proximal part intersecting the trunk portion TRex in planar view. The branch portion BR1ex includes a bottom side SD4 connecting the corner portions CR5 and CR8, a side SD5 connecting the corner portions CR5 and CR6, a top side SD6 connecting the corner portions CR6 and CR7, and a side SD7 connecting the corner portions CR7 and CR8. The bottom side SD4 and the top side SD6 are opposed to each other in the first direction X. The sides SD5 and SD7 are opposed to each other in the second direction Y. The side SD5 is inclined with respect to the trunk portion TRex. Incidentally, the side SD5 may be orthogonal to the trunk portion TRex. The side SD7 is inclined with respect to the trunk portion TRex. Incidentally, the side SD7 may be orthogonal to the trunk portion TRex. The sides SD5 and SD7 are not parallel to each other. Incidentally, the sides SD5 and SD7 may be parallel to each other. The branch portion BR1ex is formed in a trapezoidal shape having the bottom side SD4 as a lower base and the top side SD6 as an upper base in planar view. The shape of the branch portion BR1ex may be formed in a shape other than the trapezoidal shape, and for example, may be formed in a quadrangular shape (a square shape or a rectangular shape).

In the off state in which no voltage is applied between the pixel electrodes PEex1 and PEex2, the common electrode CE1ex, and the common electrode CE2ex, the major axis of each of the liquid crystal molecules LM is disposed in the initial orientation direction, for example, parallel to the first direction X as shown in FIG. 5. In a generally widely used fringe field switching (FFS) mode, when a fringing field is formed between two electrodes, all liquid crystal molecules rotate in the same direction. On the other hand, the liquid crystal molecules LM in the liquid crystal mode of the present embodiment rotates in a different manner as compared to the liquid crystal molecules in the FFS mode.

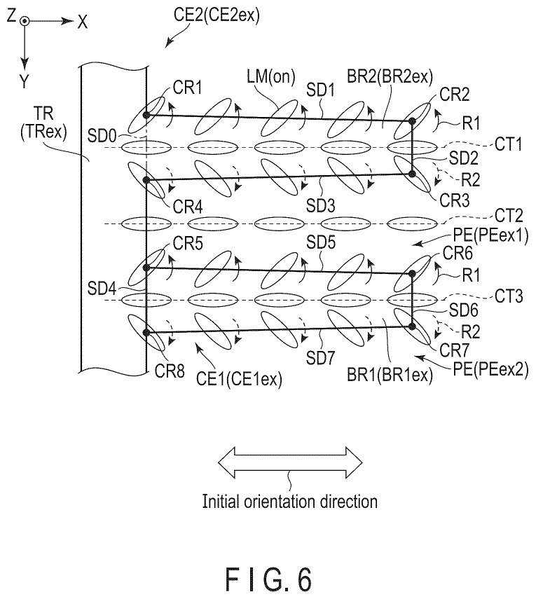

FIG. 6 is a plan view schematically showing an example of an orientation state of the liquid crystal molecules LM in the on state in which a voltage is applied between the common electrode CE and the pixel electrode PE in FIG. 5. The liquid crystal molecules LM in FIG. 6 have positive dielectric anisotropy (positive type). For this reason, a force causing the liquid crystal molecules LM to rotate acts so that the major axis is parallel (or orthogonal to the equipotential line) with respect to the direction of the electric field generated by applying the voltage between the common electrode CE and the pixel electrode PE shown in FIG. 5.

In the example shown in FIG. 6, in the vicinity of the corner portions CR1 and CR2, the liquid crystal molecules LM rotate in a rotational direction R1. In the vicinity of the corner portions CR3 and CR4, the liquid crystal molecules LM rotate in a rotational direction R2. The rotational direction R1 and the rotational direction R2 are different directions (opposite rotational directions) from each other.

In the example shown in FIG. 6, the corner portions CR1 and CR2 have a function of controlling the liquid crystal molecules LM in the vicinity of the side SD1 to rotate in the rotational direction R1 and stabilizing the orientation. That is, the liquid crystal molecules LM in the vicinity of the side SD1 rotate in the rotational direction under the influence of the rotation of the liquid crystal molecules LM at the corner portions CR1 and CR2. The corner portions CR3 and CR4 have a function of controlling the liquid crystal molecules LM in the vicinity of the side SD3 to rotate in the rotational direction R2 and stabilizing the orientation. That is, the liquid crystal molecules LM in the vicinity of the side SD3 rotate in the rotational direction under the influence of the rotation of the liquid crystal molecules LM at the corner portions CR3 and CR4.

In the example shown in FIG. 6, in the vicinity of the corner portions CR5 and CR6, the liquid crystal molecules LM rotate in the rotational direction R1. In the vicinity of the corner portions CR7 and CR8, the liquid crystal molecules LM rotate in the rotational direction R2.

In the example shown in FIG. 6, the corner portions CR5 and CR6 have a function of controlling the liquid crystal molecules LM in the vicinity of the side SD5 to rotate in the rotational direction R1 and stabilizing the orientation. That is, the liquid crystal molecules LM in the vicinity of the side SD5 rotate in the rotational direction under the influence of the rotation of the liquid crystal molecules LM at the corner portions CR5 and CR6. The corner portions CR7 and CR8 have a function of controlling the liquid crystal molecules LM in the vicinity of the side SD7 to rotate in the rotational direction R2 and stabilizing the orientation. That is, the liquid crystal molecules LM in the vicinity of the side SD7 rotate in the rotational direction under the influence of the rotation of the liquid crystal molecules LM at the corner portions CR7 and CR8.

In the vicinity of a center CT1 of the branch portion BR2ex in the second direction Y, a center CT2 between the branch portion BR1ex and the branch portion BR2ex in the second direction Y, and a center CT3 of the branch portion BR1ex in the second direction Y, the liquid crystal molecules LM rotating in the rotational direction R1 and the liquid crystal molecules LM rotating in the rotational direction R2 are in competition with each other. For this reason, the liquid crystal molecules LM in an area of the above state are maintained in the initial orientation state and hardly rotate.

As described above, in the high-speed response mode, the rotational directions R1 and R2 of the liquid crystal molecules LM are aligned from the bottom side SD0 to the top side SD2 in the vicinity of the sides SD1 and SD3. In addition, in the high-speed response mode, the rotational directions R1 and R2 of the liquid crystal molecules LM are aligned from the bottom side SD4 to the top side SD6 in the vicinity of the sides SD5 and SD7. As a result, the response speed can be increased at the time of applying a voltage to the common electrodes CE1ex and CE2ex and the pixel electrodes PEex1 and PEex2, and the orientation stability can be enhanced by suppressing variations in the rotational directions R1 and R2 of the liquid crystal molecules LM.

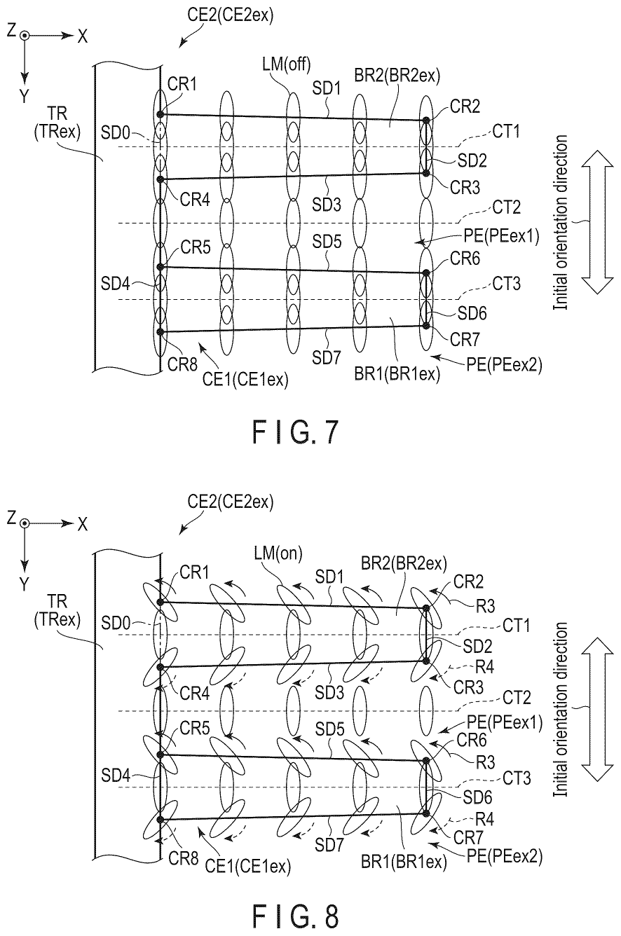

FIG. 7 is a plan view schematically showing an example of an initial orientation state of liquid crystal molecules LM contained in the liquid crystal layer LC in the off state in which no voltage is applied to the common electrode CE and the pixel electrode PE related to the high-speed response mode.

In the off state in which no voltage is applied between the pixel electrodes PEex1 and PEex2, the common electrode CE1ex, and the common electrode CE2ex, the major axis of each of the liquid crystal molecules LM is disposed in the initial orientation direction, for example, parallel to the second direction Y as shown in FIG. 7.

FIG. 8 is a plan view schematically showing an example of an orientation state of the liquid crystal molecules LM in the on state in which a voltage is applied between the common electrode CE and the pixel electrode PE in FIG. 7. The liquid crystal molecules LM in FIG. 8 have negative dielectric anisotropy (negative type). For this reason, a force causing the liquid crystal molecules LM to rotate acts so that the major axis is parallel (or orthogonal to the equipotential line) with respect to the direction of the electric field generated by applying the voltage between the common electrode CE and the pixel electrode PE shown in FIG. 7.

In the example shown in FIG. 8, in the vicinity of the corner portions CR1 and CR2, the liquid crystal molecules LM rotate in a rotational direction R3. In the vicinity of the corner portions CR3 and CR4, the liquid crystal molecules LM rotate in a rotational direction R4. The rotational direction R3 and the rotational direction R4 are different directions (opposite rotational directions) from each other.

In the example shown in FIG. 8, the corner portions CR1 and CR2 have a function of controlling the liquid crystal molecules LM in the vicinity of the side SD1 to rotate in the rotational direction R3 and stabilizing the orientation. That is, the liquid crystal molecules LM in the vicinity of the side SD1 rotate in the rotational direction under the influence of the rotation of the liquid crystal molecules LM at the corner portions CR1 and CR2. The corner portions CR3 and CR4 have a function of controlling the liquid crystal molecules LM in the vicinity of the side SD3 to rotate in the rotational direction R4 and stabilizing the orientation. That is, the liquid crystal molecules LM in the vicinity of the side SD3 rotate in the rotational direction under the influence of the rotation of the liquid crystal molecules LM at the corner portions CR3 and CR4.

In the example shown in FIG. 8, in the vicinity of the corner portions CR5 and CR6, the liquid crystal molecules LM rotate in the rotational direction R3. In the vicinity of the corner portions CR7 and CR8, the liquid crystal molecules LM rotate in the rotational direction R4.

In the example shown in FIG. 8, the corner portions CR5 and CR6 have a function of controlling the liquid crystal molecules LM in the vicinity of the side SD5 to rotate in the rotational direction R3 and stabilizing the orientation. That is, the liquid crystal molecules LM in the vicinity of the side SD5 rotate in the rotational direction under the influence of the rotation of the liquid crystal molecules LM at the corner portions CR5 and CR6. The corner portions CR7 and CR8 have a function of controlling the liquid crystal molecules LM in the vicinity of the side SD7 to rotate in the rotational direction R4 and stabilizing the orientation. That is, the liquid crystal molecules LM in the vicinity of the side SD7 rotate in the rotational direction under the influence of the rotation of the liquid crystal molecules LM at the corner portions CR7 and CR8.

In the vicinity of a center CT1 of the branch portion BR2ex in the second direction Y, a center CT2 between the branch portion BR1ex and the branch portion BR2ex in the second direction Y, and a center CT3 of the branch portion BR1ex in the second direction Y, the liquid crystal molecules LM rotating in the rotational direction R3 and the liquid crystal molecules LM rotating in the rotational direction R4 are in competition with each other. For this reason, the liquid crystal molecules LM in an area of the above state are maintained in the initial orientation state and hardly rotate.

As described above, in the high-speed response mode, the rotational directions R3 and R4 of the liquid crystal molecules LM are aligned from the bottom side SD0 to the top side SD2 in the vicinity of the sides SD1 and SD3. In addition, in the high-speed response mode, the rotational directions R3 and R4 of the liquid crystal molecules LM are aligned from the bottom side SD4 to the top side SD6 in the vicinity of the sides SD5 and SD7. As a result, the response speed can be increased at the time of applying a voltage to the common electrodes CE1ex and CE2ex and the pixel electrodes PEex1 and PEex2, and the orientation stability can be enhanced by suppressing variations in the rotational directions R3 and R4 of the liquid crystal molecules LM.

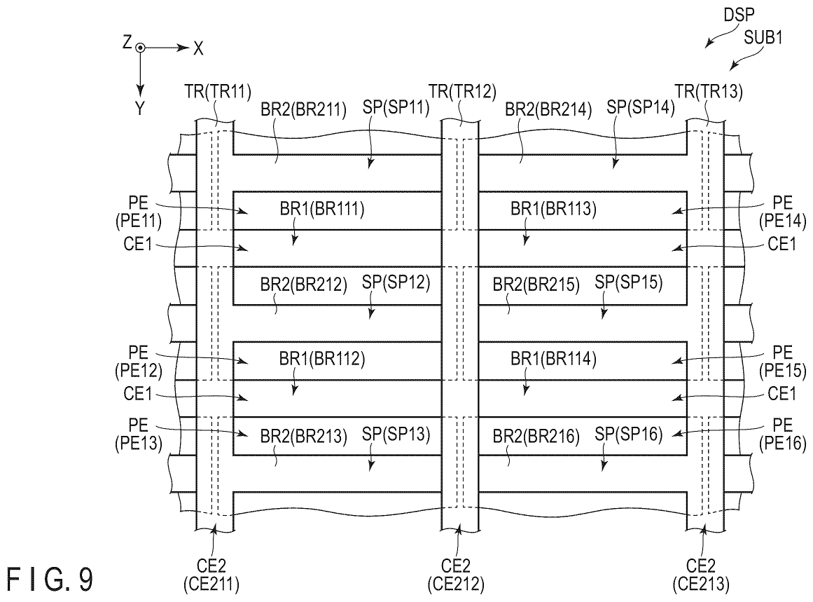

FIG. 9 is a plan view schematically showing a configuration example of the first substrate SUB1 according to the present embodiment. FIG. 9 shows only a configuration necessary for description.

The first substrate SUB1 includes the common electrode CE1, the common electrode CE2 (CE211, CE212, CE213 . . . ), the plurality of pixel electrodes PE (PE11, PE12, PE13, PE14, PE15, PE16 . . . ), and others.

The pixel electrodes PE (PE11, PE12, PE13, PE14, PE15, PE16 . . . ) are respectively disposed in the sub-pixels SP (SP11, SP12, SP13, SP14, SP15, SP16 . . . ).

In the example shown in FIG. 9, the pixel electrode PE includes the pixel electrodes PE11, PE12, PE13, PE14, PE15, PE16, and others. The pixel electrodes PE11 to PE16 are formed in a rectangular shape. Incidentally, the pixel electrodes PE11 to PE16 may be formed in a shape other than the rectangular shape. In addition, the pixel electrodes PE11 to PE16 may have slits or the like. The sizes of the pixel electrodes PE11 to PE16 are the same. Incidentally, the sizes of the pixel electrodes PE11 to PE16 may be different from each other. The pixel electrodes PE11, PE12, and PE13 are disposed at intervals toward the distal part side of the arrow in the second direction Y in the mentioned order. In other words, the pixel electrodes PE11, PE12, and PE13 are arranged at intervals toward the distal part side of the arrow in the second direction Y in the mentioned order. The pixel electrodes PE14, PE15, and PE16 are disposed at intervals toward the distal part side of the arrow in the second direction Y in the mentioned order. In other words, the pixel electrodes PE14, PE15, and PE16 are arranged at intervals toward the distal part side of the arrow in the second direction Y in the mentioned order. The pixel electrode PE14 is disposed at an interval from the pixel electrode PE11 on the distal part side of the arrow in the first direction X. In other words, the pixel electrodes PE11 and PE14 are arranged at an interval toward the distal part side of the arrow in the first direction X in the mentioned order. The pixel electrode PE15 is disposed at an interval from the pixel electrode PE12 on the distal part side of the arrow in the first direction X. In other words, the pixel electrodes PE12 and PE15 are arranged at an interval toward the distal part side of the arrow in the first direction X in the mentioned order. The pixel electrode PE16 is disposed at an interval from the pixel electrode PE13 on the distal part side of the arrow in the first direction X. In other words, the pixel electrodes PE13 and PE16 are arranged at an interval toward the distal part side of the arrow in the first direction X in the mentioned order. The pixel electrode PE11 is disposed in the sub-pixel SP11. The pixel electrode PE12 is disposed in the sub-pixel SP12. The pixel electrode PE13 is disposed in the sub-pixel SP13. The pixel electrode PE14 is disposed in the sub-pixel SP14. The pixel electrode PE15 is disposed in the sub-pixel SP15. The pixel electrode PE16 is disposed in the sub-pixel SP16.

The common electrode CE2 is disposed over the plurality of sub-pixels SP. The common electrode CE2 (CE211, CE212, CE213) includes a plurality of the trunk portions TR (TR11, TR12, TR13 . . . ) and a plurality of the branch portions BR (BR211, BR212, BR213, BR214, BR215, BR216 . . . ).

In the example shown in FIG. 9, the common electrode CE2 includes the common electrodes CE211, CE212, CE213, and others. The common electrodes CE211, CE212, and CE213 are disposed toward the distal part side of the arrow in the first direction X in the mentioned order.

The common electrode CE211 includes the trunk portion TR11 and the branch portions BR211, BR212, and BR213. The trunk portion TR11 extends in the second direction Y. The branch portions BR211, BR212, and BR213 are arranged at intervals in the second direction Y in the mentioned order. The branch portions BR211, BR212, and BR213 extend in the first direction X. The branch portions BR211 to BR213 are formed in a rectangular shape. Incidentally, the branch portions BR211 to BR213 may be formed in a shape other than the rectangular shape. The lateral widths of the branch portions BR211 to BR213 are the same. Incidentally, the lateral widths of the branch portions BR211 to BR213 may be different from each other.

The branch portion BR211 is connected to the trunk portion TR11. The branch portion BR211 extends from the trunk portion TR11 to the distal part side of the arrow in the first direction X. The distal portion of the branch portion BR211 is in contact with the common electrode CE212, for example, the trunk portion TR12 of the common electrode CE212, on the distal part side of the arrow in the first direction X. Incidentally, the distal portion of the branch portion BR211 on the distal part side of the arrow in the first direction X may be separated from the common electrode CE212, for example, the trunk portion TR12 of the common electrode CE212. The branch portion BR211 is disposed in the sub-pixel SP11. The branch portion BR211 overlaps with the pixel electrode PE11. For example, the branch portion BR211 overlaps with the central portion in the longitudinal width of the pixel electrode PE11.

Incidentally, the branch portion BR211 may overlap with the pixel electrode PE11 while being shifted in the second direction Y from the central portion in the longitudinal width of the pixel electrode PE11. The branch portion BR212 is connected to the trunk portion TR11. The branch portion BR212 extends from the trunk portion TR11 to the distal part side of the arrow in the first direction X. The distal portion of the branch portion BR212 is in contact with the trunk portion TR12, on the distal part side of the arrow in the first direction X. Incidentally, the distal portion of the branch portion BR212 on the distal part side of the arrow in the first direction X may be separated from the trunk portion TR12. The branch portion BR212 is disposed in the sub-pixel SP12. The branch portion BR212 overlaps with the pixel electrode PE12. For example, the branch portion BR212 overlaps with the central portion in the longitudinal width of the pixel electrode PE12. Incidentally, the branch portion BR212 may overlap with the pixel electrode PE12 while being shifted in the second direction Y from the central portion in the longitudinal width of the pixel electrode PE12.

The branch portion BR213 is connected to the trunk portion TR11. The branch portion BR213 extends from the trunk portion TR11 to the distal part side of the arrow in the first direction X. The distal portion of the branch portion BR213 is in contact with the common electrode CE212, for example, the trunk portion TR12 of the common electrode CE212, on the distal part side of the arrow in the first direction X. Incidentally, the distal portion of the branch portion BR213 on the distal part side of the arrow in the first direction X may be separated from the common electrode CE212, for example, the trunk portion TR12 of the common electrode CE212. The branch portion BR213 is disposed in the sub-pixel SP13. The branch portion BR213 overlaps with the pixel electrode PE13. For example, the branch portion BR213 overlaps with the central portion in the longitudinal width of the pixel electrode PE13. Incidentally, the branch portion BR213 may overlap with the pixel electrode PE13 while being shifted in the second direction Y from the central portion in the longitudinal width of the pixel electrode PE13.

The common electrode CE212 includes the trunk portion TR12. The trunk portion TR12 extends in the second direction Y.

The common electrode CE213 includes the trunk portion TR13 and the branch portions BR214, BR215, and BR216. The trunk portion TR13 extends in the second direction Y. The branch portions BR214, BR215, and BR216 are arranged at intervals in the second direction Y in the mentioned order. The branch portions BR214, BR215, and BR216 extend in the first direction X. The branch portions BR214 to BR216 are formed in a rectangular shape. Incidentally, the branch portions BR214 to BR216 may be formed in a shape other than the rectangular shape. The lateral widths of the branch portions BR214 to BR216 are the same. Incidentally, the lateral widths of the branch portions BR214 to BR216 may be different from each other.

The branch portion BR214 is connected to the trunk portion TR13. The branch portion BR214 extends from the trunk portion TR13 to the opposite side to the distal part side of the arrow in the first direction X. The distal portion of the branch portion BR214, on the opposite side to the distal part side of the arrow in the first direction X, is in contact with the common electrode CE212, for example, the trunk portion TR12 of the common electrode CE212. Incidentally, the distal portion of the branch portion BR214, on the opposite side to the distal part side of the arrow in the first direction X, may be separated from the common electrode CE212, for example, the trunk portion TR12 of the common electrode CE212. The branch portion BR214 is disposed in the sub-pixel SP14. The branch portion BR214 overlaps with the pixel electrode PE14. For example, the branch portion BR214 overlaps with the central portion in the longitudinal width of the pixel electrode PE14. Incidentally, the branch portion BR214 may overlap with the pixel electrode PE14 while being shifted in the second direction Y from the central portion in the longitudinal width of the pixel electrode PE14.

The branch portion BR215 is connected to the trunk portion TR13. The branch portion BR215 extends from the trunk portion TR13 to the opposite side to the distal part side of the arrow in the first direction X. The distal portion of the branch portion BR215, on the opposite side to the distal part side of the arrow in the first direction X, is in contact with the common electrode CE212, for example, the trunk portion TR12 of the common electrode CE212. Incidentally, the distal portion of the branch portion BR215, on the opposite side to the distal part side of the arrow in the first direction X, may be separated from the common electrode CE212, for example, the trunk portion TR12 of the common electrode CE212. The branch portion BR215 is disposed in the sub-pixel SP15. The branch portion BR215 overlaps with the pixel electrode PE15. For example, the branch portion BR215 overlaps with the central portion in the longitudinal width of the pixel electrode PE15. Incidentally, the branch portion BR215 may overlap with the pixel electrode PE15 while being shifted in the second direction Y from the central portion in the longitudinal width of the pixel electrode PE15.

The branch portion BR216 is connected to the trunk portion TR13. The branch portion BR216 extends from the trunk portion TR13 to the opposite side to the distal part side of the arrow in the first direction X. The distal portion of the branch portion BR216 is in contact with the common electrode CE212, for example, the trunk portion TR12 of the common electrode CE212, on the opposite side to the distal part side of the arrow in the first direction X. Incidentally, the distal portion of the branch portion BR216 on the opposite side to the distal part side of the arrow in the first direction X may be separated from the common electrode CE212, for example, the trunk portion TR12 of the common electrode CE212. The branch portion BR216 is disposed in the sub-pixel SP16. The branch portion BR216 overlaps with the pixel electrode PE16. For example, the branch portion BR216 overlaps with the central portion in the longitudinal width of the pixel electrode PE16. Incidentally, the branch portion BR216 may overlap with the pixel electrode PE16 while being shifted in the second direction Y from the central portion in the longitudinal width of the pixel electrode PE16.

The common electrode CE1 is disposed over the plurality of sub-pixels SP. In the example shown in FIG. 9, the common electrode CE1 extends in the X-Y plane. In other words, the common electrode CE1 is disposed in a solid manner on the X-Y plane. The common electrode CE1 is disposed over the plurality of sub-pixels SP11 to SP16. The common electrode CE1 overlaps with the pixel electrodes PE (PE11 to PE16) and the common electrodes CE2 (BR211 to BR216) in the respective sub-pixels SP (SP11 to SP16). The common electrode CE1 is exposed from between the plurality of pixel electrodes PE. The common electrode CE1 includes the branch portion BR1 (BR111, BR112, BR113, and BR114) exposed from between the two pixel electrodes PE adjacent to each other in the second direction Y. In the example shown in FIG. 9, the branch portion BR1 and the branch portion BR2 are alternately disposed in the second direction Y. In other words, the branch portion BR1 and the branch portion BR2 are adjacent to each other in the second direction Y.

In the example shown in FIG. 9, the common electrode CE1 includes the branch portions BR111, BR112, BR113, and BR114. The branch portions BR111 and BR112 are arranged at an interval toward the distal part side of the arrow in the second direction Y in the mentioned order. The branch portions BR113 and BR114 are arranged at an interval toward the distal part side of the arrow in the second direction Y in the mentioned order. The branch portions BR111 and BR113 are arranged at an interval toward the distal part side of the arrow in the first direction X in the mentioned order. The branch portions BR112 and BR114 are arranged at an interval toward the distal part side of the arrow in the first direction X in the mentioned order. The branch portions BR111 to BR114 extend in the first direction X. The branch portions BR111 to BR114 are formed in a rectangular shape. Incidentally, the branch portions BR111 to BR114 may be formed in a shape other than the rectangular shape. In addition, the shapes of the branch portions BR111 to BR114 may be the same as or different from the shapes of the branch portions BR211 to BR216. The lateral widths of the branch portions BR111 to BR114 are the same. Incidentally, the lateral widths of the branch portions BR111 to BR114 may be different from each other.

The branch portion BR111 is exposed from between the trunk portions TR11 and TR12 and between the pixel electrodes PE11 and PE12. The branch portion BR111 extends from the trunk portion TR11 to the trunk portion TR12 in the first direction X. The branch portion BR111 is disposed between the branch portions BR211 and BR212 in the second direction Y. For example, the branch portion BR111 is located in the central portion in the second direction Y between the branch portions BR211 and BR212. Incidentally, the branch portion BR111 may be located while being shifted from the central portion in the second direction Y between the branch portions BR211 and BR212.

The branch portion BR112 is exposed from between the trunk portions TR11 and TR12 and between the pixel electrodes PE12 and PE13. The branch portion BR112 extends from the trunk portion TR11 to the trunk portion TR12 in the first direction X. The branch portion BR112 is disposed between the branch portions BR212 and BR213 in the second direction Y. For example, the branch portion BR112 is located in the central portion in the second direction Y between the branch portions BR212 and BR213. Incidentally, the branch portion BR112 may be located while being shifted from the central portion in the second direction Y between the branch portions BR212 and BR213.

The branch portion BR113 is exposed from between the trunk portions TR12 and TR13 and between the pixel electrodes PE14 and PE15. The branch portion BR113 extends from the trunk portion TR13 to the trunk portion TR12 in the first direction X. The branch portion BR113 is disposed between the branch portions BR214 and BR215 in the second direction Y. For example, the branch portion BR113 is located in the central portion in the second direction Y between the branch portions BR214 and BR215. Incidentally, the branch portion BR113 may be located while being shifted from the central portion in the second direction Y between the branch portions BR214 and BR215.

The branch portion BR114 is exposed from between the trunk portions TR12 and TR13 and between the pixel electrodes PE15 and PE16. The branch portion BR114 extends from the trunk portion TR13 to the trunk portion TR12 in the first direction X. The branch portion BR114 is disposed between the branch portions BR215 and BR216 in the second direction Y. For example, the branch portion BR114 is located in the central portion in the second direction Y between the branch portions BR215 and BR216. Incidentally, the branch portion BR114 may be located while being shifted from the central portion in the second direction Y between the branch portions BR215 and BR216.

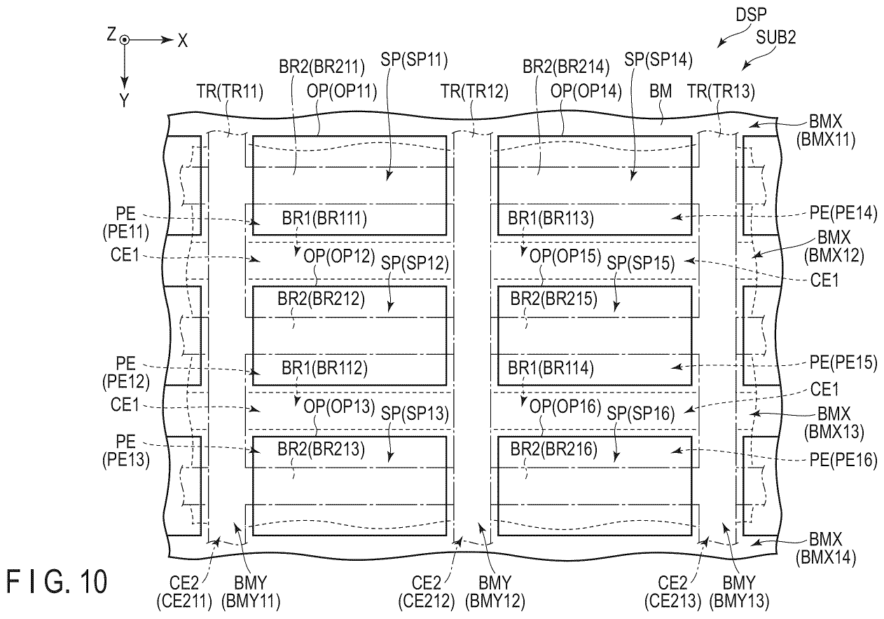

FIG. 10 is a plan view schematically showing a configuration example of the second substrate SUB2 according to the present embodiment. Incidentally, FIG. 10 shows only a configuration necessary for description. The configuration shown in FIG. 10 corresponds to the configuration shown in FIG. 9.

The second substrate SUB2 includes the light-shielding layer BM. The light-shielding layer BM has light-shielding properties. In the example shown in FIG. 10, the light-shielding layer BM is formed in a lattice shape. Incidentally, the light-shielding layer BM may have a configuration other than the lattice shape, such as a ladder shape or a stripe shape. For example, the light-shielding layer BM includes a longitudinal part BMY and a lateral part BMX. The longitudinal parts BMY are arranged at intervals in the first direction X and extend in the second direction Y. In planar view, the longitudinal part BMY overlaps with the trunk portion TR. The longitudinal part BMY is formed in a belt shape having a substantially constant width in the first direction X. The lateral parts BMX are arranged at intervals in the second direction Y and extend in the first direction X. In planar view, the lateral part BMX overlaps with the branch portion BR1. The lateral part BMX is formed in a band shape having a substantially constant width in the second direction Y.

In the example shown in FIG. 10, the light-shielding layer BM includes longitudinal parts BMY11, BMY12, and BMY13, and lateral parts BMX11, BMX12, BMX13, and BMX14. The longitudinal parts BMY11, BMY12, and BMY13 have substantially the same lateral width, and are arranged at regular intervals in the first direction X. The longitudinal parts BMY11 to BMY13 respectively extend in the second direction Y along the trunk portions TR11 to TR13, and overlap with the trunk portions TR11 to TR13.

The lateral parts BMX11, BMX12, BMX13, and BMX14 have substantially the same longitudinal width, and are arranged at regular intervals in the second direction Y in the mentioned order. The lateral part BMX11 extends in the first direction X. The lateral part BMX12 extends along the branch portions BR111 and BR113 and overlaps with the branch portions BR111 and BR113. The lateral part BMX13 extends along the branch portions BR112 and BR114 and overlaps with the branch portions BR112 and BR114. The lateral part BMX14 extends in the first direction X.

The light-shielding layer BM includes a plurality of the opening portions OP (OP11, OP12, OP13, OP14, OP15, OP16 . . . ). The plurality of opening portions OP are areas that are partitioned by the light-shielding layer BM and contribute to display. The plurality of opening portions OP are arranged in a matrix on the X-Y plane. The plurality of opening portions OP have the same shape and the same size. Incidentally, the plurality of opening portions OP may have different shapes and different sizes from each other.

In the example shown in FIG. 10, the light-shielding layer BM includes the plurality of opening portions OP11, OP12, OP13, OP14, OP15, OP16, and others. The opening portions OP (OP11, OP12, OP13, OP14, OP15, OP16 . . . ) are formed in a rectangular shape. Incidentally, the opening portions OP (OP11, OP12, OP13, OP14, OP15, OP16 . . . ) may be formed in a shape other than the rectangular shape. The lateral widths of the opening portions OP (OP11, OP12, OP13, OP14, OP15, OP16 . . . ) are equal to or less than the lateral width of the branch portion BR2. For example, the lateral widths of the opening portions OP (OP11, OP12, OP13, OP14, OP15, OP16 . . . ) are substantially the same as the lateral width of the branch portion BR2. The longitudinal widths of the opening portions OP (OP11, OP12, OP13, OP14, OP15, OP16 . . . ) are larger than the longitudinal width of the branch portion BR2 and are less than the longitudinal width of the pixel electrode PE.

In the example shown in FIG. 10, the opening portions OP11, OP12, OP13, OP14, OP15, and OP16 are arranged in a matrix. The opening portions OP11, OP12, and OP13 are arranged at regular intervals in the second direction Y in the mentioned order. The opening portions OP14, OP15, and OP16 are arranged at regular intervals on the distal part side of the arrow in the second direction Y in the mentioned order. The opening portions OP11 and OP14 are arranged at an interval toward the distal part side of the arrow in the first direction X in the mentioned order. The opening portions OP12 and OP15 are arranged at an interval toward the distal part side of the arrow in the first direction X in the mentioned order. The opening portions OP13 and OP16 are arranged at an interval toward the distal part side of the arrow in the first direction X in the mentioned order.

The opening portion OP11 is defined by the longitudinal parts BMY11 and BMY12 and the lateral parts BMX11 and BMX12. The opening portion OP11 is disposed in the sub-pixel SP11. The opening portion OP11 overlaps with the common electrode CE1, the branch portion BR211, the pixel electrode PE11, and others. The opening portion OP12 is defined by the longitudinal parts BMY11 and BMY12 and the lateral parts BMX12 and BMX13. The opening portion OP12 is disposed in the sub-pixel SP12. The opening portion OP12 overlaps with the common electrode CE1, the branch portion BR212, the pixel electrode PE12, and others. The opening portion OP13 is defined by the longitudinal parts BMY11 and BMY12 and the lateral parts BMX13 and BMX14. The opening portion OP13 is disposed in the sub-pixel SP13. The opening portion OP13 overlaps with the common electrode CE1, the branch portion BR213, the pixel electrode PE13, and others. The opening portion OP14 is defined by the longitudinal parts BMY12 and BMY13 and the lateral parts BMX11 and BMX12. The opening portion OP14 is disposed in the sub-pixel SP14. The opening portion OP14 overlaps with the common electrode CE1, the branch portion BR214, the pixel electrode PE14, and others. The opening portion OP15 is defined by the longitudinal parts BMY12 and BMY13 and the lateral parts BMX12 and BMX13. The opening portion OP15 is disposed in the sub-pixel SP15. The opening portion OP15 overlaps with the common electrode CE1, the branch portion BR215, the pixel electrode PE15, and others. The opening portion OP16 is defined by the longitudinal parts BMY12 and BMY13 and the lateral parts BMX13 and BMX14. The opening portion OP16 is disposed in the sub-pixel SP16. The opening portion OP16 overlaps with the common electrode CE1, the branch portion BR216, the pixel electrode PE16, and others.

According to the present embodiment, the display device DSP includes the first substrate SUB1 and the second substrate SUB2 opposed to the first substrate SUB1. The first substrate SUB1 includes the pixel electrode PE, the common electrode CE1, and the common electrode CE2. The common electrode CE2 has the trunk portion TR extending in the second direction Y and the plurality of branch portions BR2 extending from the trunk portion TR in the first direction X. The plurality of branch portions BR2 are arranged at regular intervals in the second direction Y. The branch portion BR2 overlaps with the pixel electrode PE and the common electrode CE1. The common electrode CE1 has the branch portion BR1 exposed from between the two pixel electrodes PE adjacent to each other in the second direction Y. The branch portion BR1 extends from the trunk portion TR in the first direction X. The branch portion BR1 and the branch portion BR2 are alternately disposed in the second direction Y. In other words, the branch portion BR1 and the branch portion BR2 are adjacent to each other in the second direction Y. The second substrate SUB2 includes the light-shielding layer BM including the opening portion OP. The opening portion OP overlaps with the branch portion BR2, the pixel electrode PE, and the common electrode CE1. Because the branch portion BR1 and the branch portion BR2 are alternately disposed, the branch portion BR2 of the common electrode CE2 can be easily patterned in the case of obtaining high definition. The patterning of the branch portion BR1 exposed from between the two pixel electrodes PE adjacent to each other can be omitted or simplified. Therefore, by alternately arranging the branch portion BR1 and the branch portion BR2, a space of the configuration for realizing the high-speed response mode can be saved. In addition, the display device DSP can achieve high definition and an improved response speed. For this reason, the display device DSP that can be easily manufactured and can display a high-quality image can be provided.

Next, display devices DSP according to modified examples and other embodiments are described. In the modified examples and other embodiments described below, the same parts as those of the display device DSP of the first embodiment described above are denoted by the same reference numerals, and the detailed description thereof are omitted or simplified, and parts different from those of the display device DSP of the first embodiment are mainly described in detail. Incidentally, in the modified examples and other embodiments, the same effects as those of the embodiment described above can be obtained.

### Modified Example 1

A display device DSP according to Modified Example 1 of the first embodiment is different from the display device DSP of the first embodiment in the configurations of a first substrate SUB1 and a second substrate SUB2.

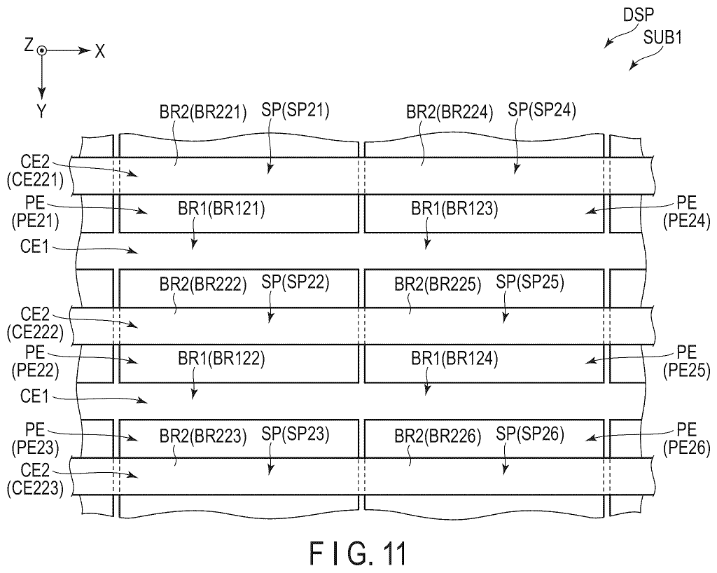

FIG. 11 is a plan view schematically showing a configuration example of the first substrate SUB1 according to the display device DSP of Modified Example 1. FIG. 11 shows only a configuration necessary for description.

Pixel electrodes PE (PE21, PE22, PE23, PE24, PE25, PE26 . . . ) are respectively disposed in sub-pixels SP (SP21, SP22, SP23, SP24, SP25, SP26 . . . ).

In the example shown in FIG. 11, the pixel electrode PE includes the pixel electrodes PE21, PE22, PE23, PE24, PE25, PE26, and others. The pixel electrodes PE21 to PE26 are formed in a rectangular shape. Incidentally, the pixel electrodes PE21 to PE26 may be formed in a shape other than the rectangular shape. In addition, the pixel electrodes PE21 to PE26 may have slits or the like. The sizes of the pixel electrodes PE21 to PE26 are the same. Incidentally, the sizes of the pixel electrodes PE21 to PE26 may be different from each other. The pixel electrodes PE21, PE22, and PE23 are disposed at intervals toward the distal part side of the arrow in the second direction Y in the mentioned order. In other words, the pixel electrodes PE21, PE22, and PE23 are arranged at intervals toward the distal part side of the arrow in the second direction Y in the mentioned order. The pixel electrodes PE24, PE25, and PE26 are disposed at intervals toward the distal part side of the arrow in the second direction Y in the mentioned order. In other words, the pixel electrodes PE24, PE25, and PE26 are arranged at intervals toward the distal part side of the arrow in the second direction Y in the mentioned order. The pixel electrodes PE21 and PE24 are arranged at an interval toward the distal part side of the arrow in the first direction X in the mentioned order. The pixel electrodes PE22 and PE25 are arranged at an interval toward the distal part side of the arrow in the first direction X in the mentioned order. The pixel electrodes PE23 and PE26 are arranged at an interval toward the distal part side of the arrow in the first direction X in the mentioned order. The pixel electrode PE21 is disposed in the sub-pixel SP21. The pixel electrode PE22 is disposed in the sub-pixel SP22. The pixel electrode PE23 is disposed in the sub-pixel SP23. The pixel electrode PE24 is disposed in the sub-pixel SP24. The pixel electrode PE25 is disposed in the sub-pixel SP25. The pixel electrode PE26 is disposed in the sub-pixel SP26.

In the example shown in FIG. 11, a common electrode CE2 includes common electrodes CE221, CE222, CE223, and others. The common electrodes CE221, CE222, and CE223 are disposed toward the distal part side of the arrow in the second direction Y in the mentioned order. The common electrodes CE221 to CE223 are formed in an extending belt shape. Incidentally, the common electrodes CE221 to CE223 may be formed in a shape other than the extending belt shape.

The common electrode CE221 extends in the first direction X. The common electrode CE221 includes branch portions BR221 and BR224. The branch portions BR221 and BR224 are arranged in the first direction X in the mentioned order. In other words, the branch portions BR221 and BR224 are continuously disposed on a straight line in the first direction X. The branch portion BR221 is disposed in the sub-pixel SP21. The branch portion BR221 overlaps with the pixel electrode PE21. For example, the branch portion BR221 overlaps with the central portion in the longitudinal width of the pixel electrode PE21. Incidentally, the branch portion BR221 may overlap with the pixel electrode PE21 while being shifted in the second direction Y from the central portion in the longitudinal width of the pixel electrode PE21. The branch portion BR224 is disposed in the sub-pixel SP24. The branch portion BR224 overlaps with the pixel electrode PE24. For example, the branch portion BR224 overlaps with the central portion in the longitudinal width of the pixel electrode PE24. Incidentally, the branch portion BR224 may overlap with the pixel electrode PE24 while being shifted in the second direction Y from the central portion in the longitudinal width of the pixel electrode PE24.

The common electrode CE222 extends in the first direction X. The common electrode CE222 includes branch portions BR222 and BR225. The branch portions BR222 and BR225 are arranged in the first direction X in the mentioned order. In other words, the branch portions BR222 and BR225 are continuously disposed on a straight line in the first direction X. The branch portion BR222 is disposed in the sub-pixel SP22. The branch portion BR222 overlaps with the pixel electrode PE22. For example, the branch portion BR222 overlaps with the central portion in the longitudinal width of the pixel electrode PE22. Incidentally, the branch portion BR222 may overlap with the pixel electrode PE22 while being shifted in the second direction Y from the central portion in the longitudinal width of the pixel electrode PE22. The branch portion BR225 is disposed in the sub-pixel SP25. The branch portion BR225 overlaps with the pixel electrode PE25. For example, the branch portion BR225 overlaps with the central portion in the longitudinal width of the pixel electrode PE25. Incidentally, the branch portion BR225 may overlap with the pixel electrode PE25 while being shifted in the second direction Y from the central portion in the longitudinal width of the pixel electrode PE25.

The common electrode CE223 extends in the first direction X. The common electrode CE223 includes branch portions BR223 and BR226. The branch portions BR223 and BR226 are arranged in the first direction X in the mentioned order. In other words, the branch portions BR223 and BR226 are continuously disposed on a straight line in the first direction X. The branch portion BR223 is disposed in the sub-pixel SP23. The branch portion BR223 overlaps with the pixel electrode PE23. For example, the branch portion BR223 overlaps with the central portion in the longitudinal width of the pixel electrode PE23. Incidentally, the branch portion BR223 may overlap with the pixel electrode PE23 while being shifted in the second direction Y from the central portion in the longitudinal width of the pixel electrode PE23. The branch portion BR226 is disposed in the sub-pixel SP26. The branch portion BR226 overlaps with the pixel electrode PE26. For example, the branch portion BR226 overlaps with the central portion in the longitudinal width of the pixel electrode PE26. Incidentally, the branch portion BR226 may overlap with the pixel electrode PE26 while being shifted in the second direction Y from the central portion in the longitudinal width of the pixel electrode PE26.

In the example shown in FIG. 11, a common electrode CE1 includes branch portions BR121, BR122, BR123, and BR124. The branch portions BR121 and BR122 are arranged at an interval toward the distal part side of the arrow in the second direction Y in the mentioned order. The branch portions BR123 and BR124 are arranged at an interval toward the distal part side of the arrow in the second direction Y in the mentioned order. The branch portions BR121 and BR123 are arranged at an interval toward the distal part side of the arrow in the first direction X in the mentioned order. In other words, the branch portions BR121 and BR123 are continuously disposed on a straight line in the first direction X. The branch portions BR122 and BR124 are arranged at an interval toward the distal part side of the arrow in the first direction X in the mentioned order. In other words, the branch portions BR122 and BR124 are continuously disposed on a straight line in the first direction X.

The branch portion BR121 is exposed from between the pixel electrodes PE21 and PE22. The branch portion BR121 extends along the pixel electrodes PE21 and PE22 in the first direction X. The branch portion BR121 is disposed between the branch portions BR221 and BR222 in the second direction Y. For example, the branch portion BR121 is located in the central portion in the second direction Y between the branch portions BR221 and BR222. Incidentally, the branch portion BR121 may be located while being shifted from the central portion in the second direction Y between the branch portions BR221 and BR222. The branch portion BR121 extends along the branch portions BR221 and BR222 in the first direction X.

The branch portion BR122 is exposed from between the pixel electrodes PE22 and PE23. The branch portion BR122 extends along the pixel electrodes PE22 and PE23 in the first direction X. The branch portion BR122 is disposed between the branch portions BR222 and BR223 in the second direction Y. For example, the branch portion BR122 is located in the central portion in the second direction Y between the branch portions BR222 and BR223. Incidentally, the branch portion BR122 may be located while being shifted from the central portion in the second direction Y between the branch portions BR222 and BR223. The branch portion BR122 extends along the branch portions BR222 and BR223 in the first direction X.

The branch portion BR123 is exposed from between the pixel electrodes PE24 and PE25. The branch portion BR123 extends along the pixel electrodes PE24 and PE25 in the first direction X. The branch portion BR123 is disposed between the branch portions BR224 and BR225 in the second direction Y. For example, the branch portion BR123 is located in the central portion in the second direction Y between the branch portions BR224 and BR225. Incidentally, the branch portion BR123 may be located while being shifted from the central portion in the second direction Y between the branch portions BR224 and BR225. The branch portion BR123 extends along the branch portions BR224 and BR225 in the first direction X.

The branch portion BR124 is exposed from between the pixel electrodes PE25 and PE26. The branch portion BR124 extends along the pixel electrodes PE25 and PE26 in the first direction X. The branch portion BR124 is disposed between the branch portions BR225 and BR226 in the second direction Y. For example, the branch portion BR124 is located in the central portion in the second direction Y between the branch portions BR225 and BR226. Incidentally, the branch portion BR124 may be located while being shifted from the central portion in the second direction Y between the branch portions BR225 and BR226. The branch portion BR124 extends along the branch portions BR225 and BR226 in the first direction X.

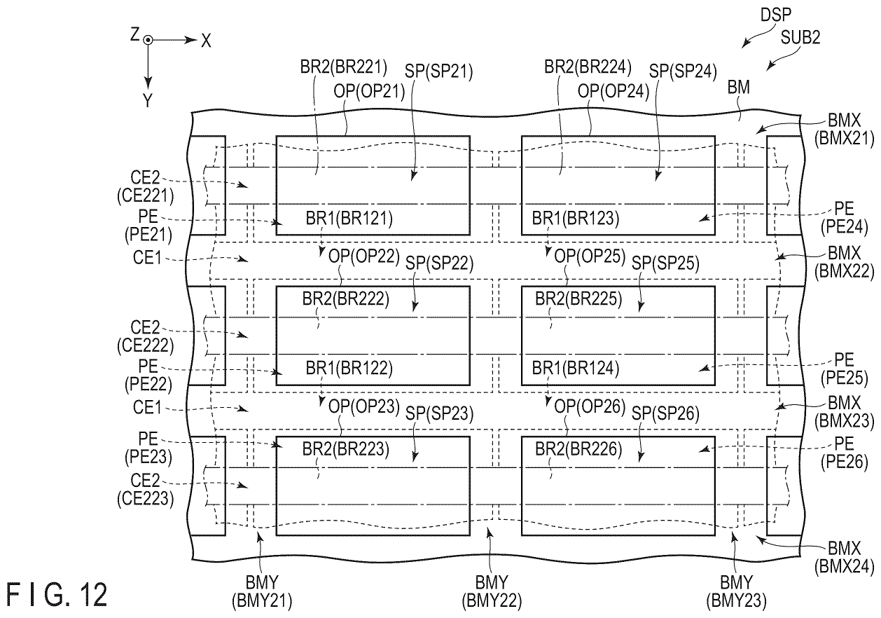

FIG. 12 is a plan view schematically showing a configuration example of the second substrate SUB2 according to Modified Example 1. Incidentally, FIG. 12 shows only a configuration necessary for description. The configuration shown in FIG. 12 corresponds to the configuration shown in FIG. 11.

In the example shown in FIG. 12, a light-shielding layer BM includes longitudinal parts BMY21, BMY22, and BMY23, and lateral parts BMX21, BMX22, BMX23, and BMX24. The longitudinal parts BMY21, BMY22, and BMY23 have substantially the same lateral width, and are arranged at regular intervals in the first direction X. The longitudinal part BMY21 extends in the second direction Y and overlaps with the end portions of the pixel electrodes PE21, PE22, and PE23 on the opposite side to the distal part side of the arrow in the first direction X. The longitudinal part BMY22 extends in the second direction Y and overlaps with the end portions of the pixel electrodes PE21, PE22, and PE23 on the distal part side of the arrow in the first direction X, and on the end portions of the pixel electrodes PE24, PE25, and PE26 on the opposite side to the distal part side of the arrow in the first direction X. The longitudinal part BMY23 extends in the second direction Y and overlaps with the end portions of the pixel electrodes PE24, PE25, and PE26 on the distal part side of the arrow in the first direction X. The longitudinal parts BMY21 to BMY23 overlap over the common electrodes CE221, CE222, and CE223.

The lateral parts BMX21, BMX22, BMX23, and BMX24 have substantially the same longitudinal width, and are arranged at regular intervals in the second direction Y in the mentioned order. The lateral part BMX21 extends in the first direction X. The lateral part BMX22 extends along the branch portions BR121 and BR123 in the first direction X and overlaps with the branch portions BR121 and BR123. The lateral part BMX23 extends along the branch portions BR122 and BR124 in the first direction X and overlaps with the branch portions BR122 and BR124. The lateral part BMX24 extends in the first direction X.

In the example shown in FIG. 12, the light-shielding layer BM includes opening portions OP21, OP22, OP23, OP24, OP25, OP26, and others. The opening portions OP (OP21, OP22, OP23, OP24, OP25, OP26 . . . ) are formed in a rectangular shape. Incidentally, the opening portions OP (OP21, OP22, OP23, OP24, OP25, OP26 . . . ) may be formed in a shape other than the rectangular shape. The lateral widths of the opening portions OP (OP21, OP22, OP23, OP24, OP25, OP26 . . . ) are equal to or less than the lateral width of the branch portion BR2. For example, the lateral widths of the opening portions OP (OP21, OP22, OP23, OP24, OP25, OP26 . . . ) are substantially the same as the lateral width of the branch portion BR2. The longitudinal widths of the opening portions OP (OP21, OP22, OP23, OP24, OP25, OP26 . . . ) are larger than the longitudinal width of the branch portion BR2 and are less than the longitudinal width of the pixel electrode PE.

In the example shown in FIG. 12, the opening portions OP21, OP22, OP23, OP24, OP25, and OP26 are arranged in a matrix. The opening portions OP21, OP22, and OP23 are arranged at regular intervals in the second direction Y in the mentioned order. The opening portions OP24, OP25, and OP26 are arranged at regular intervals on the distal part side of the arrow in the second direction Y in the mentioned order. The opening portions OP21 and OP24 are arranged at an interval toward the distal part side of the arrow in the first direction X in the mentioned order. The opening portions OP22 and OP25 are arranged at an interval toward the distal part side of the arrow in the first direction X in the mentioned order. The opening portions OP23 and OP26 are arranged at an interval toward the distal part side of the arrow in the first direction X in the mentioned order.

The opening portion OP21 is defined by the longitudinal parts BMY21 and BMY22 and the lateral parts BMX21 and BMX22. The opening portion OP21 is disposed in the sub-pixel SP21. The opening portion OP21 overlaps with the common electrode CE1, the branch portion BR221, the pixel electrode PE21, and others. The opening portion OP22 is defined by the longitudinal parts BMY21 and BMY22 and the lateral parts BMX22 and BMX23. The opening portion OP22 is disposed in the sub-pixel SP22. The opening portion OP22 overlaps with the common electrode CE1, the branch portion BR222, the pixel electrode PE22, and others. The opening portion OP23 is defined by the longitudinal parts BMY21 and BMY22 and the lateral parts BMX23 and BMX24. The opening portion OP23 is disposed in the sub-pixel SP23. The opening portion OP23 overlaps with the common electrode CE1, the branch portion BR223, the pixel electrode PE23, and others. The opening portion OP24 is defined by the longitudinal parts BMY22 and BMY23 and the lateral parts BMX21 and BMX22. The opening portion OP24 is disposed in the sub-pixel SP24. The opening portion OP24 overlaps with the common electrode CE1, the branch portion BR224, the pixel electrode PE24, and others. The opening portion OP25 is defined by the longitudinal parts BMY22 and BMY23 and the lateral parts BMX22 and BMX23. The opening portion OP25 is disposed in the sub-pixel SP25. The opening portion OP25 overlaps with the common electrode CE1, the branch portion BR225, the pixel electrode PE25, and others. The opening portion OP26 is defined by the longitudinal parts BMY22 and BMY23 and the lateral parts BMX23 and BMX24. The opening portion OP26 is disposed in the sub-pixel SP26. The opening portion OP26 overlaps with the common electrode CE1, the branch portion BR226, the pixel electrode PE26, and others.

Modified Example 1 as described above has the same effect as that of the first embodiment. In addition, the display device DSP of Modified Example 1 can be easily manufactured as compared with the display device DSP of the first embodiment.

### Modified Example 2

A display device DSP according to Modified Example 2 of the first embodiment is different from the display devices DSP of the first embodiment and Modified Example 1 in the configurations of a first substrate SUB1 and a second substrate SUB2.

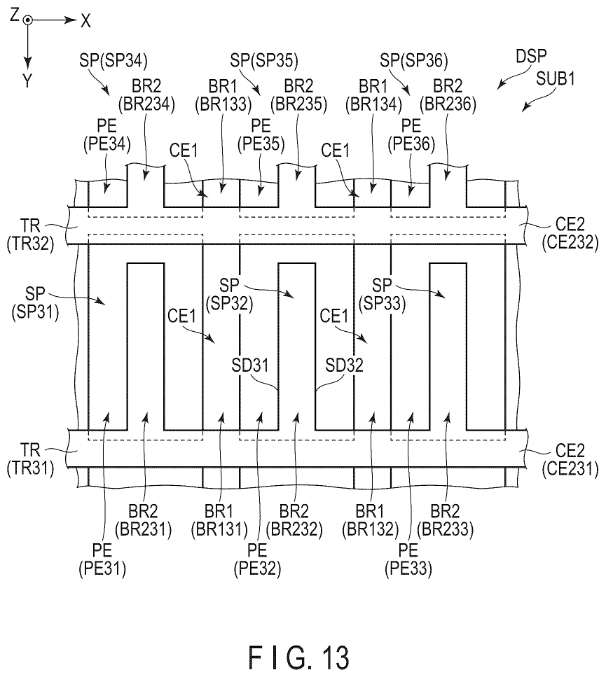

FIG. 13 is a plan view schematically showing a configuration example of the first substrate SUB1 according to the display device DSP of Modified Example 2. FIG. 13 shows only a configuration necessary for description.

In the example shown in FIG. 13, a pixel electrode PE includes pixel electrodes PE31, PE32, PE33, PE34, PE35, PE36, and others. The pixel electrodes PE31 to PE36 are formed in a rectangular shape. Incidentally, the pixel electrodes PE31 to PE36 may be formed in a shape other than the rectangular shape. In addition, the pixel electrodes PE31 to PE36 may have slits or the like. The pixel electrodes PE31, PE32, and PE33 are disposed at intervals toward the distal part side of the arrow in the first direction X in the mentioned order. In other words, the pixel electrodes PE31, PE32, and PE33 are arranged at intervals toward the distal part side of the arrow in the first direction X in the mentioned order. The pixel electrodes PE34, PE35, and PE36 are disposed at intervals toward the distal part side of the arrow in the first direction X in the mentioned order. In other words, the pixel electrodes PE34, PE35, and PE36 are arranged at intervals toward the distal part side of the arrow in the first direction X in the mentioned order. The pixel electrodes PE31 and PE34 are arranged at an interval toward the opposite side to the distal part side of the arrow in the second direction Y in the mentioned order. The pixel electrodes PE32 and PE35 are arranged at an interval toward the opposite side to the distal part side of the arrow in the second direction Y in the mentioned order. The pixel electrodes PE33 and PE36 are arranged at an interval toward the opposite side to the distal part side of the arrow in the second direction Y in the mentioned order. The pixel electrode PE31 is disposed in a sub-pixel SP31. The pixel electrode PE32 is disposed in a sub-pixel SP32. The pixel electrode PE33 is disposed in a sub-pixel SP33. The pixel electrode PE34 is disposed in a sub-pixel SP34. The pixel electrode PE35 is disposed in a sub-pixel SP35. The pixel electrode PE36 is disposed in a sub-pixel SP36.

In the example shown in FIG. 13, a common electrode CE2 includes common electrodes CE231, CE232, and others. The common electrodes CE231 and CE232 are disposed toward the opposite side to the distal part side of the arrow in the second direction Y in the mentioned order.

The common electrode CE231 includes a trunk portion TR31 and branch portions BR231, BR232, and BR233. The trunk portion TR31 extends in the first direction X. The branch portions BR231, BR232, and BR233 are arranged at intervals in the first direction X in the mentioned order. For example, the branch portion BR232 includes sides SD31 and SD32. The sides SD31 and SD32 intersect the trunk portion TR31. In the example shown in FIG. 13, the sides SD31 and SD32 are parallel to each other. The branch portion BR232 extends in the second direction Y. For example, the branch portion BR232 is formed in a rectangular shape. The branch portions BR231 and BR233 extend in the second direction Y. Similarly to the branch portion BR232, the branch portions BR231 and BR233 are formed in a rectangular shape. Incidentally, the branch portions BR231 to BR233 may be formed in a shape other than the rectangular shape. The lateral widths of the branch portions BR231 to BR233 are the same. Incidentally, the lateral widths of the branch portions BR231 to BR233 may be different from each other.

The branch portion BR231 is connected to the trunk portion TR31. The branch portion BR231 extends from the trunk portion TR31 to the opposite side to the distal part side of the arrow in the second direction Y. The distal portion of the branch portion BR231, on the opposite side to the distal part side of the arrow in the second direction Y, is separated from the common electrode CE232, for example, a trunk portion TR32 of the common electrode CE232. Incidentally, the distal portion of the branch portion BR231, on the opposite side to the distal part side of the arrow in the second direction Y, may be in contact with the common electrode CE232, for example, the trunk portion TR32 of the common electrode CE232. The branch portion BR231 is disposed in the sub-pixel SP31. The branch portion BR231 overlaps with the pixel electrode PE31. For example, the branch portion BR231 overlaps with the central portion in the lateral width of the pixel electrode PE31. Incidentally, the branch portion BR231 may overlap with the pixel electrode PE31 while being shifted in the first direction X from the central portion in the lateral width of the pixel electrode PE31.

The branch portion BR232 is connected to the trunk portion TR31. The branch portion BR232 extends from the trunk portion TR31 to the opposite side to the distal part side of the arrow in the second direction Y. The distal portion of the branch portion BR232, on the opposite side to the distal part side of the arrow in the second direction Y, is separated from the common electrode CE232, for example, the trunk portion TR32 of the common electrode CE232. Incidentally, the distal portion of the branch portion BR232, on the opposite side to the distal part side of the arrow in the second direction Y, may be in contact with the common electrode CE232, for example, the trunk portion TR32 of the common electrode CE232. The branch portion BR232 is disposed in the sub-pixel SP32. The branch portion BR232 overlaps with the pixel electrode PE32. For example, the branch portion BR232 overlaps with the central portion in the lateral width of the pixel electrode PE32. Incidentally, the branch portion BR232 may overlap with the pixel electrode PE32 while being shifted in the first direction X from the central portion in the lateral width of the pixel electrode PE32.

The branch portion BR233 is connected to the trunk portion TR31. The branch portion BR233 extends from the trunk portion TR31 to the opposite side to the distal part side of the arrow in the second direction Y. The distal portion of the branch portion BR233, on the opposite side to the distal part side of the arrow in the second direction Y, is separated from the common electrode CE232, for example, the trunk portion TR32 of the common electrode CE232. Incidentally, the distal portion of the branch portion BR233, on the opposite side to the distal part side of the arrow in the second direction Y, may be in contact with the common electrode CE232, for example, the trunk portion TR32 of the common electrode CE232. The branch portion BR233 is disposed in the sub-pixel SP33. The branch portion BR233 overlaps with the pixel electrode PE33. For example, the branch portion BR233 overlaps with the central portion in the lateral width of the pixel electrode PE33. Incidentally, the branch portion BR233 may overlap with the pixel electrode PE33 while being shifted in the first direction X from the central portion in the lateral width of the pixel electrode PE33.

The common electrode CE232 includes the trunk portion TR32 and branch portions BR234, BR235, and BR236. The trunk portion TR32 extends in the first direction X. The branch portions BR234, BR235, and BR236 are arranged at intervals in the first direction X in the mentioned order. The branch portions BR234 to BR236 extend in the second direction Y. Similarly to the branch portion BR232, the branch portions BR234 to BR236 are formed in a rectangular shape. Incidentally, the branch portions BR234 to BR236 may be formed in a shape other than the rectangular shape. The lateral widths of the branch portions BR234 to BR236 are the same. Incidentally, the lateral widths of the branch portions BR234 to BR236 may be different from each other.

The branch portion BR234 is connected to the trunk portion TR32. The branch portion BR234 extends from the trunk portion TR32 to the opposite side to the distal part side of the arrow in the second direction Y. The branch portion BR234 is disposed in the sub-pixel SP34. The branch portion BR234 overlaps with the pixel electrode PE34. For example, the branch portion BR234 overlaps with the central portion in the lateral width of the pixel electrode PE34. Incidentally, the branch portion BR234 may overlap with the pixel electrode PE34 while being shifted in the first direction X from the central portion in the lateral width of the pixel electrode PE34.

The branch portion BR235 is connected to the trunk portion TR32. The branch portion BR235 extends from the trunk portion TR32 to the opposite side to the distal part side of the arrow in the second direction Y. The branch portion BR235 is disposed in the sub-pixel SP35. The branch portion BR235 overlaps with the pixel electrode PE35. For example, the branch portion BR235 overlaps with the central portion in the lateral width of the pixel electrode PE35. Incidentally, the branch portion BR235 may overlap with the pixel electrode PE35 while being shifted in the first direction X from the central portion in the lateral width of the pixel electrode PE35.

The branch portion BR236 is connected to the trunk portion TR32. The branch portion BR236 extends from the trunk portion TR32 to the opposite side to the distal part side of the arrow in the second direction Y. The branch portion BR236 is disposed in the sub-pixel SP36. The branch portion BR236 overlaps with the pixel electrode PE36. For example, the branch portion BR236 overlaps with the central portion in the lateral width of the pixel electrode PE36. Incidentally, the branch portion BR236 may overlap with the pixel electrode PE36 while being shifted in the first direction X from the central portion in the lateral width of the pixel electrode PE36.

In the example shown in FIG. 13, branch portions BR1 and branch portions BR2 are alternately disposed in the first direction X. In other words, the branch portion BR1 and the branch portion BR2 are adjacent to each other in the first direction X.

In the example shown in FIG. 13, a common electrode CE1 includes branch portions BR131, BR132, BR133, and BR134. The branch portions BR131 and BR132 are arranged at an interval toward the distal part side of the arrow in the first direction X in the mentioned order. The branch portions BR133 and BR134 are arranged at an interval toward the distal part side of the arrow in the first direction X in the mentioned order. The branch portions BR131 and BR133 are arranged at an interval toward the opposite side to the distal part side of the arrow in the second direction Y in the mentioned order. The branch portions BR132 and BR134 are arranged at an interval toward the opposite side to the distal part side of the arrow in the second direction Y in the mentioned order. The branch portions BR131 to BR134 extend in the second direction Y. The branch portions BR131 to BR134 are formed in a rectangular shape. Incidentally, the branch portions BR131 to BR134 may be formed in a shape other than the rectangular shape. In addition, the shapes of the branch portions BR131 to BR134 may be the same as or different from the shapes of the branch portions BR231 to BR236. The lateral widths of the branch portions BR131 to BR134 are the same. Incidentally, the lateral widths of the branch portions BR131 to BR134 may be different from each other.

The branch portion BR131 is exposed from between the trunk portions TR31 and TR32 and the pixel electrodes PE31 and PE32. In other words, the branch portion BR131 corresponds to the common electrode CE1 exposed from between the trunk portions TR31 and TR32 and the pixel electrodes PE31 and PE32. The branch portion BR131 extends from the trunk portion TR31 to TR32 in the second direction Y. The branch portion BR131 is disposed between the branch portions BR231 and BR232 in the first direction X. For example, the branch portion BR131 is located in the central portion in the first direction X between the branch portion BR231 and BR232. Incidentally, the branch portion BR131 may be located while being shifted from the central portion in the first direction X between the branch portion BR231 and BR232.

The branch portion BR132 is exposed from between the trunk portions TR31 and TR32 and the pixel electrodes PE32 and PE33. In other words, the branch portion BR132 corresponds to the common electrode CE1 exposed from between the trunk portions TR31 and TR32 and the pixel electrodes PE32 and PE33. The branch portion BR132 extends from the trunk portion TR31 to TR32 in the second direction Y. The branch portion BR132 is disposed between the branch portions BR232 and BR233 in the first direction X. For example, the branch portion BR132 is located in the central portion in the first direction X between the branch portion BR232 and BR233. Incidentally, the branch portion BR132 may be located while being shifted from the central portion in the first direction X between the branch portion BR232 and BR233.

The branch portion BR133 is exposed from between the trunk portion TR32 and the pixel electrodes PE34 and PE35. In other words, the branch portion BR133 corresponds to the common electrode CE1 exposed from between the trunk portion TR32 and the pixel electrodes PE34 and PE35. The branch portion BR133 extends from the trunk portion TR32 in the second direction Y. The branch portion BR133 is disposed between the branch portions BR234 and BR235 in the first direction X. For example, the branch portion BR133 is located in the central portion in the first direction X between the branch portion BR234 and BR235. Incidentally, the branch portion BR133 may be located while being shifted from the central portion in the first direction X between the branch portion BR234 and BR235.

The branch portion BR134 is exposed from between the trunk portion TR32 and the pixel electrodes PE35 and PE36. In other words, the branch portion BR134 corresponds to the common electrode CE1 exposed from between the trunk portions TR32 and the pixel electrodes PE35 and PE36. The branch portion BR134 extends from the trunk portion TR32 to the opposite side to the distal part side of the arrow in the second direction Y. The branch portion BR134 is disposed between the branch portions BR235 and BR236 in the first direction X. For example, the branch portion BR134 is located in the central portion in the first direction X between the branch portion BR235 and BR236. Incidentally, the branch portion BR134 may be located while being shifted from the central portion in the first direction X between the branch portion BR235 and BR236.

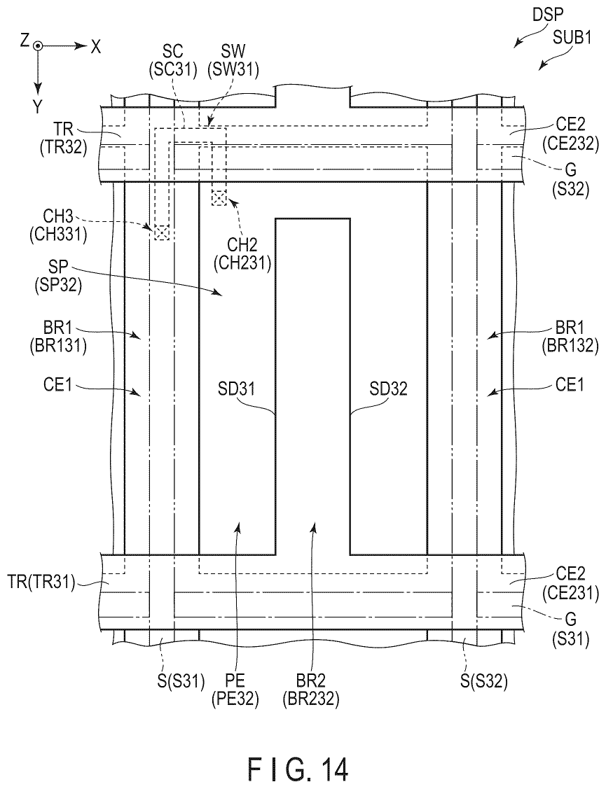

FIG. 14 is a schematic view schematically showing an example of the sub-pixel SP. For example, FIG. 14 shows the sub-pixel SP32.

The sub-pixel SP is defined by two signal lines S adjacent to each other and two scanning lines G adjacent to each other. The sub-pixel SP includes a switching element SW, the pixel electrode PE, the common electrode CE1, the common electrode CE2, and others. The branch portion BR1 of the common electrode CE1 overlaps with the signal line S. The trunk portion TR of the common electrode CE2 overlaps with the scanning line G. The switching element SW includes a semiconductor layer SC. The semiconductor layer SC is connected to the pixel electrode PE through a contact hole CH2 (CH231), and is connected to the signal line S through a contact hole CH3 (CH331).

In the example shown in FIG. 14, signal lines S31 and S32 are disposed at an interval toward the distal part side of the arrow in the first direction X in the mentioned order. The signal lines S31 and S32 are adjacent to each other in the first direction X. Scanning lines G31 and G32 are disposed at an interval toward the opposite side to the distal part side of the arrow in the second direction Y in the mentioned order. The scanning lines G31 and G32 are adjacent to each other in the second direction Y. The sub-pixel SP32 is defined by the signal lines S31 and S32 and the scanning lines G31 and G32. The sub-pixel SP32 includes a switching element SW31, the pixel electrode PE32, the common electrode CE1 (BR131 and BR132), the common electrode CE2 (CE231 and CE232), and others. The common electrode CE1 includes the branch portions BR131 and BR132. The branch portion BR131 overlaps with the signal line S31. The branch portion BR132 overlaps with the signal line S32. The common electrode CE231 includes the trunk portion TR31 and the branch portion BR232. The trunk portion TR31 overlaps with the scanning line G31. The common electrode CE232 includes the trunk portion TR32. The trunk portion TR32 overlaps with the scanning line G32. The switching element SW31 includes a semiconductor layer SC31. The semiconductor layer SC31 is connected to the pixel electrode PE32 through the contact hole CH231, and is connected to the signal line S31 through the contact hole CH331.

In the example shown in FIG. 14, the switching element SW is a double-gate type in which the semiconductor layer SC intersects the scanning line G twice. Incidentally, the switching element SW may be a single-gate type in which the semiconductor layer SC intersects the scanning lines G only once.

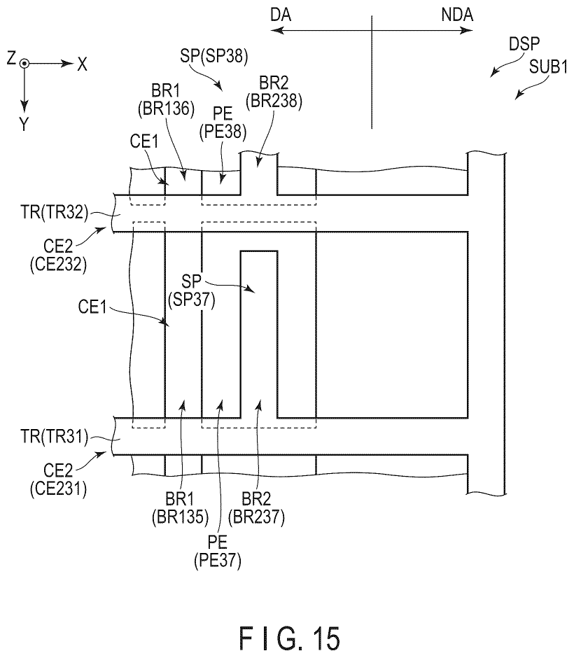

FIG. 15 is a plan view schematically showing a configuration example of the common electrode CE2 in the non-display area NDA according to Modified Example 2. FIG. 15 shows only a configuration necessary for description. The configuration shown in FIG. 15 corresponds to the configuration shown in FIG. 13.

In the example shown in FIG. 15, the pixel electrode PE includes pixel electrodes PE37, PE38, and others. The pixel electrodes PE37 and PE38 are formed in a rectangular shape. Incidentally, the pixel electrodes PE37 and PE38 may be formed in a shape other than the rectangular shape. In addition, the pixel electrodes PE37 and PE38 may have slits or the like. The pixel electrodes PE37 and PE38 are disposed at the end portion of the display area DA on the distal part side of the arrow in the first direction X. The pixel electrodes PE37 and PE38 are arranged at an interval toward the opposite side to the distal part side of the arrow in the second direction Y in the mentioned order. The pixel electrode PE37 is disposed in a sub-pixel SP37. The pixel electrode PE38 is disposed in a sub-pixel SP38.

In the example shown in FIG. 15, the common electrode CE2 includes the common electrodes CE231, CE232, and others. The common electrode CE231 includes a branch portion BR237. The branch portion BR237 is formed in a rectangular shape. Incidentally, the branch portion BR237 may be formed in a shape other than the rectangular shape.

The branch portion BR237 is connected to the trunk portion TR31. The branch portion BR237 extends from the trunk portion TR31 to the opposite side to the distal part side of the arrow in the second direction Y. The distal portion of the branch portion BR237, on the opposite side to the distal part side of the arrow in the second direction Y, is separated from the common electrode CE232, for example, the trunk portion TR32 of the common electrode CE232. Incidentally, the distal portion of the branch portion BR237, on the opposite side to the distal part side of the arrow in the second direction Y, may be in contact with the common electrode CE232, for example, the trunk portion TR32 of the common electrode CE232. The branch portion BR237 is disposed in the sub-pixel SP37. The branch portion BR237 overlaps with the pixel electrode PE37. For example, the branch portion BR237 overlaps with the central portion in the lateral width of the pixel electrode PE37. Incidentally, the branch portion BR237 may overlap with the pixel electrode PE37 while being shifted in the first direction X from the central portion in the lateral width of the pixel electrode PE37.

The common electrode CE232 includes a branch portion BR238. The branch portion BR238 is formed in a rectangular shape. Incidentally, the branch portion BR238 may be formed in a shape other than the rectangular shape.

The branch portion BR238 is connected to the trunk portion TR32. The branch portion BR238 extends from the trunk portion TR32 to the opposite side to the distal part side of the arrow in the second direction Y. The branch portion BR238 is disposed in the sub-pixel SP38. The branch portion BR238 overlaps with the pixel electrode PE38. For example, the branch portion BR238 overlaps with the central portion in the lateral width of the pixel electrode PE38. Incidentally, the branch portion BR238 may overlap with the pixel electrode PE38 while being shifted in the first direction X from the central portion in the lateral width of the pixel electrode PE38.

In the example shown in FIG. 15, the common electrode CE231 and the common electrode CE232 extend in the second direction Y and are connected to each other in the non-display area NDA.

In the example shown in FIG. 15, the common electrode CE1 includes branch portions BR135 and BR136. The branch portions BR135 and BR136 are arranged at an interval toward the opposite side to the distal part side of the arrow in the second direction Y in the mentioned order. The branch portions BR135 and BR136 are formed in a rectangular shape. Incidentally, the branch portions BR135 to BR136 may be formed in a shape other than the rectangular shape. In addition, the shapes of the branch portions BR135 and BR136 may be the same as or different from the shapes of the branch portions BR237 and BR238.

The branch portion BR135 is exposed in an area between the trunk portions TR31 and TR32 and adjacent to the opposite side to the distal part side of the pixel electrode PE37 in the first direction X. The branch portion BR135 extends from the trunk portion TR31 to TR32 in the second direction Y.

The branch portion BR136 is exposed in an area adjacent to the trunk portion TR32 on the opposite side to the distal part side of the arrow in the second direction Y and in an area adjacent to the pixel electrode PE38 on the opposite side to the distal part side of the arrow in the first direction X. The branch portion BR136 extends from the trunk portion TR32 to the opposite side to the distal part side of the arrow in the second direction Y.

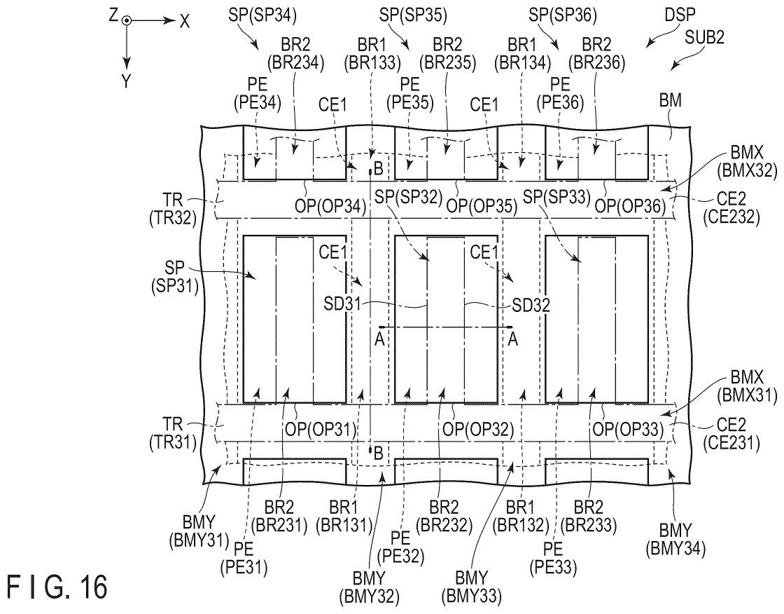

FIG. 16 is a plan view schematically showing a configuration example of the second substrate SUB2 according to Modified Example 2. Incidentally, FIG. 16 shows only a configuration necessary for description. The configuration shown in FIG. 16 corresponds to the configuration shown in FIG. 13.

In the example shown in FIG. 16, a light-shielding layer BM includes longitudinal parts BMY31, BMY32, BMY33, and BMY34, and lateral parts BMX31 and BMX32. The longitudinal parts BMY31, BMY32, BMY33, and BMY34 have substantially the same lateral width, and are arranged at regular intervals in the first direction X. The longitudinal part BMY31 extends in the second direction Y and overlaps with the end portions of the pixel electrodes PE31 and PE34 on the opposite side to the distal part side of the arrow in the first direction X. The longitudinal part BMY32 extends in the second direction Y and overlaps with the branch portions BR131 and BR133. The longitudinal part BMY33 extends in the second direction Y and overlaps with the branch portions BR132 and BR134. The longitudinal part BMY34 extends in the second direction Y and overlaps with the end portions of the pixel electrodes PE33 and PE36 on the distal part side of the arrow in the first direction X.

The lateral parts BMX31 and BMX32 have substantially the same longitudinal width, and are arranged at a regular interval in the second direction Y in the mentioned order. The lateral part BMX31 extends in the first direction X and overlaps with the trunk portion TR31. The lateral part BMX32 extends in the first direction X and overlaps with the trunk portion TR32.

In the example shown in FIG. 16, the light-shielding layer BM includes opening portions OP31, OP32, OP33, OP34, OP35, OP36, and others. The opening portions OP31, OP32, OP33, OP34, OP35, and OP36 are arranged in a matrix. The opening portions OP31, OP32, and OP33 are arranged at regular intervals in the first direction X in the mentioned order. The opening portions OP34, OP35, and OP36 are arranged at regular intervals in the first direction X in the mentioned order. The opening portions OP31 and OP34 are arranged at an interval toward the opposite side to the distal part side of the arrow in the second direction Y in the mentioned order. The opening portions OP32 and OP35 are arranged at an interval toward the opposite side to the distal part side of the arrow in the second direction Y in the mentioned order. The opening portions OP33 and OP36 are arranged at an interval toward the opposite side to the distal part side of the arrow in the second direction Y in the mentioned order.

The opening portion OP31 is defined by the longitudinal parts BMY31 and BMY32 and the lateral parts BMX31 and BMX32. The opening portion OP31 is disposed in the sub-pixel SP31. The opening portion OP31 overlaps with the common electrode CE1, the branch portion BR231, the pixel electrode PE31, and others. The opening portion OP32 is defined by the longitudinal parts BMY32 and BMY33 and the lateral parts BMX31 and BMX32. The opening portion OP32 is disposed in the sub-pixel SP32. The opening portion OP32 overlaps with the common electrode CE1, the branch portion BR232, the pixel electrode PE32, and others. The opening portion OP33 is defined by the longitudinal parts BMY33 and BMY34 and the lateral parts BMX31 and BMX32. The opening portion OP33 is disposed in the sub-pixel SP33. The opening portion OP33 overlaps with the common electrode CE1, the branch portion BR233, the pixel electrode PE33, and others. The opening portion OP34 is defined by the longitudinal parts BMY31 and BMY32 and the lateral part BMX32. The opening portion OP34 is disposed in the sub-pixel SP34. The opening portion OP34 overlaps with the common electrode CE1, the branch portion BR234, the pixel electrode PE34, and others. The opening portion OP35 is defined by the longitudinal parts BMY32 and BMY33 and the lateral part BMX32. The opening portion OP35 is disposed in the sub-pixel SP35. The opening portion OP35 overlaps with the common electrode CE1, the branch portion BR235, the pixel electrode PE35, and others. The opening portion OP36 is defined by the longitudinal parts BMY33 and BMY34 and the lateral part BMX32. The opening portion OP36 is disposed in the sub-pixel SP36. The opening portion OP36 overlaps with the common electrode CE1, the branch portion BR236, the pixel electrode PE36, and others.

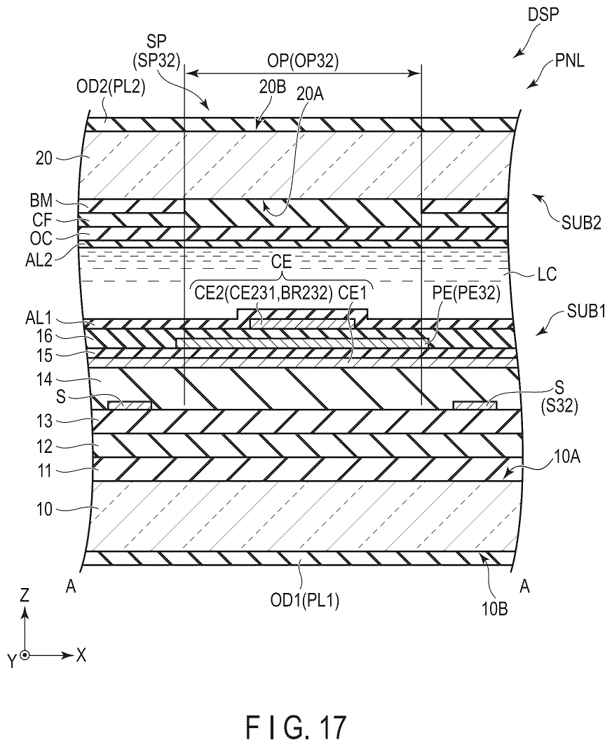

FIG. 17 is a cross-sectional view schematically showing a configuration example of the display device DSP cut along A-A in FIG. 16. Incidentally, FIG. 17 shows only a configuration necessary for description.

The signal line S is located on an insulating layer 13 and is in contact with the insulating layer 13. In the example shown in FIG. 17, the two signal lines S31 and S32 are located on the insulating layer 13 and disposed at an interval in the first direction X. An insulating layer 14 is located on the insulating layer 13 and the signal lines S31 and S32, and is in contact with the insulating layer 13 and the signal lines S31 and S32.

The pixel electrode PE32 is located on an insulating layer 15 and is in contact with the insulating layer 15. An insulating layer 16 is located on the insulating layer 15 and the pixel electrode PE32, and covers the insulating layer 15 and the pixel electrode PE32. The pixel electrode PE32 overlaps with the opening portion OP32. The lateral width of the pixel electrode PE32 is substantially the same as the lateral width of the opening portion OP32. Incidentally, the lateral width of the pixel electrode PE32 may be larger than the lateral width of the opening portions OP32.

The common electrode CE231 includes the branch portion BR232. The branch portion BR232 is located on the insulating layer 16 and is in contact with the insulating layer 16. The branch portion BR232 extends in the first direction X. The lateral width of the branch portion BR232 is smaller than the lateral width of the pixel electrode PE32. For example, the branch portion BR232 overlaps with the central portion in the lateral width of the pixel electrode PE32. Incidentally, the branch portion BR232 may overlap with the pixel electrode PE32 while being shifted in the first direction from the central portion in the lateral width of the pixel electrode PE32.

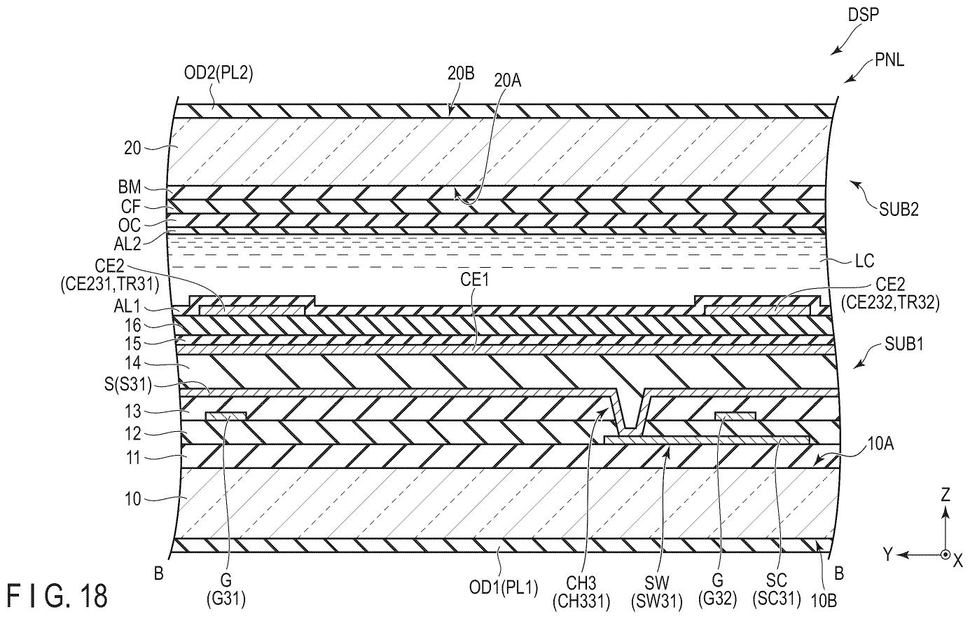

FIG. 18 is a cross-sectional view schematically showing a configuration example of the display device DSP cut along B-B in FIG. 16. Incidentally, FIG. 18 shows only a configuration necessary for description. The branch portion BR232 overlaps with the opening portion OP32.

The first substrate SUB1 includes the common electrode CE2 (CE231 (TR31), CE232 (TR32)), the contact hole CH3 (CH331), the switching element SW (SW31), and others. The common electrode CE2 includes the common electrodes CE231 and CE232. The common electrode CE231 includes the trunk portion TR31. The common electrode CE232 includes the trunk portion TR32. The trunk portions TR31 and TR32 are located on the insulating layer 16 and is in contact with the insulating layer 16. The trunk portions TR31 and TR32 are disposed at an interval in the second direction Y. The contact hole CH331 is formed by penetrating the insulating layers 12 and 13. The switching element SW31 includes the semiconductor layer SC31. The switching element SW31 is electrically connected to the signal line S31 through the contact hole CH331. The scanning lines G (G31 and G32) are located on the insulating layer 12 and are in contact with the insulating layer 12. In other words, the scanning lines G (G31 and G32) are located between the insulating layers 12 and 13. The scanning lines G (G31 and G32) may be located on other layers. For example, the scanning lines G (G31 and G32) are located below the common electrode CE1.

Modified Example 2 as described above has the same effect as that of the first embodiment.

### Modified Example 3

A display device DSP according to Modified Example 3 of the first embodiment is different from the display devices DSP of the first embodiment, Modified Example 1, and Modified Example 2 described above in terms of the configuration of a common electrode CE2.

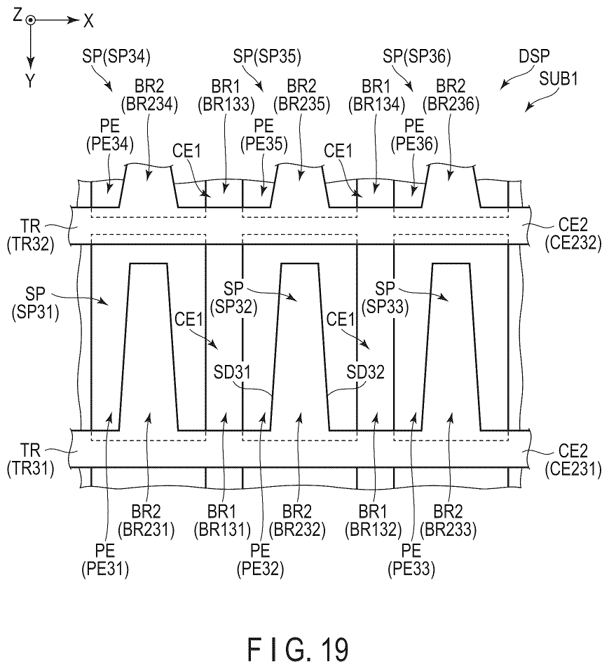

FIG. 19 is a plan view schematically showing a configuration example of a first substrate SUB1 according to the display device DSP of Modified Example 3. FIG. 19 shows only a configuration necessary for description. The configuration shown in FIG. 19 corresponds to the configuration shown in FIG. 13.

In the example shown in FIG. 19, sides SD31 and SD32 are not parallel to each other. For example, a branch portion BR232 is formed in a trapezoidal shape tapered toward the opposite side to the distal part side of the arrow in the second direction Y. For example, branch portions BR231 and BR233 to BR236 are also formed in a trapezoidal shape tapered toward the opposite side to the distal part side of the arrow in the second direction Y. Incidentally, the branch portions BR231 to BR236 may be formed in a shape other than the trapezoidal shape.

Modified Example 3 as described above has the same effect as that of the first embodiment. In addition, a shape of the branch portion BR2 of the display device DSP of Modified Example 3 can improve the orientation stability as compared with the shape of the branch portion BR2 of the above-described embodiment and Modified Examples.

### Modified Example 4

A display device DSP according to Modified Example 4 of the first embodiment is different from the display device DSP of Modified Example 3 described above in the configuration of a common electrode CE1.

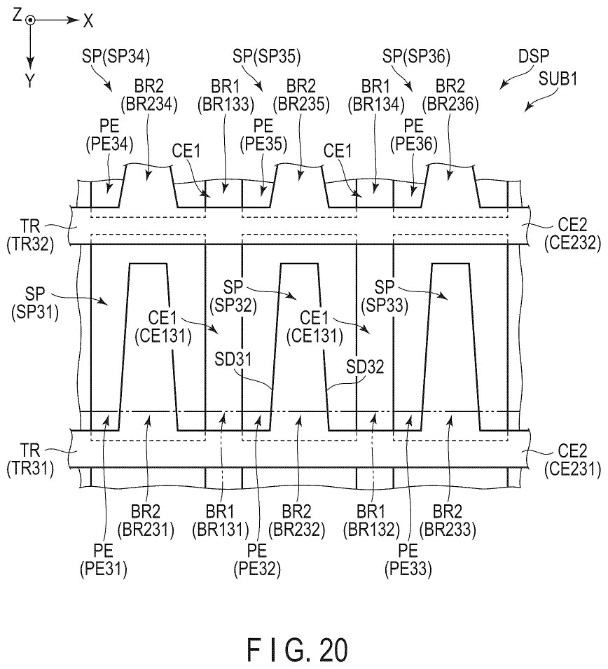

FIG. 20 is a plan view schematically showing a configuration example of a first substrate SUB1 according to the display device DSP of Modified Example 4. FIG. 20 shows only a configuration necessary for description. The configuration shown in FIG. 20 corresponds to the configuration shown in FIG. 19.

In the example shown in FIG. 20, the common electrode CE1 includes a common electrode CE131. The common electrode CE131 extends in the first direction X. The common electrode CE131 overlaps over branch portions BR231, BR232, and BR233. In addition, the common electrode CE131 overlaps over pixel electrodes PE31, PE32, and PE33. The common electrode CE131 is disposed separated from a trunk portion TR31 to the opposite side to the distal part side of the arrow in the second direction Y. In other words, the common electrode CE131 is disposed at an interval from the trunk portion TR31, on the opposite side to the distal part side of the arrow in the second direction Y. For example, the common electrode CE131 does not overlap with portions of sides SD31 and SD32. For example, the common electrode CE131 does not overlap with portions of sides SD31 and SD32 on the distal part side of the arrow in the second direction Y.

The common electrode CE131 includes branch portions BR131 and BR132. The branch portion BR131 is exposed in an area separated from the trunk portion TR31 to the opposite side to the distal part side of the arrow in the second direction Y. In other words, the branch portion BR131 is located at an interval from the trunk portion TR31 on the opposite side to the distal part side of the arrow in the second direction Y. The branch portion BR132 is also exposed in an area separated from the trunk portion TR31 to the opposite side to the distal part side of the arrow in the second direction Y. In other words, the branch portion BR132 is also located at an interval from the trunk portion TR31 on the opposite side to the distal part side of the arrow in the second direction Y.

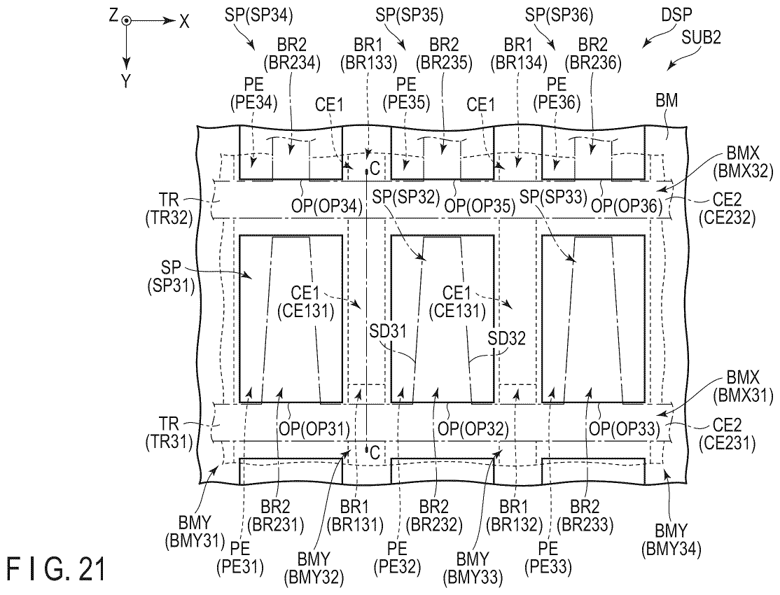

FIG. 21 is a plan view schematically showing a configuration example of a second substrate SUB2 according to Modified Example 4. Incidentally, FIG. 21 shows only a configuration necessary for description. The configuration shown in FIG. 21 corresponds to the configuration shown in FIG. 20.

In the example shown in FIG. 21, a portion of each of opening portions OP31 to OP33 does not overlap with the common electrode CE131. For example, a portion of each of the opening portions OP31 to OP33 on the distal part side of the arrow in the second direction Y does not overlap with the common electrode CE131.

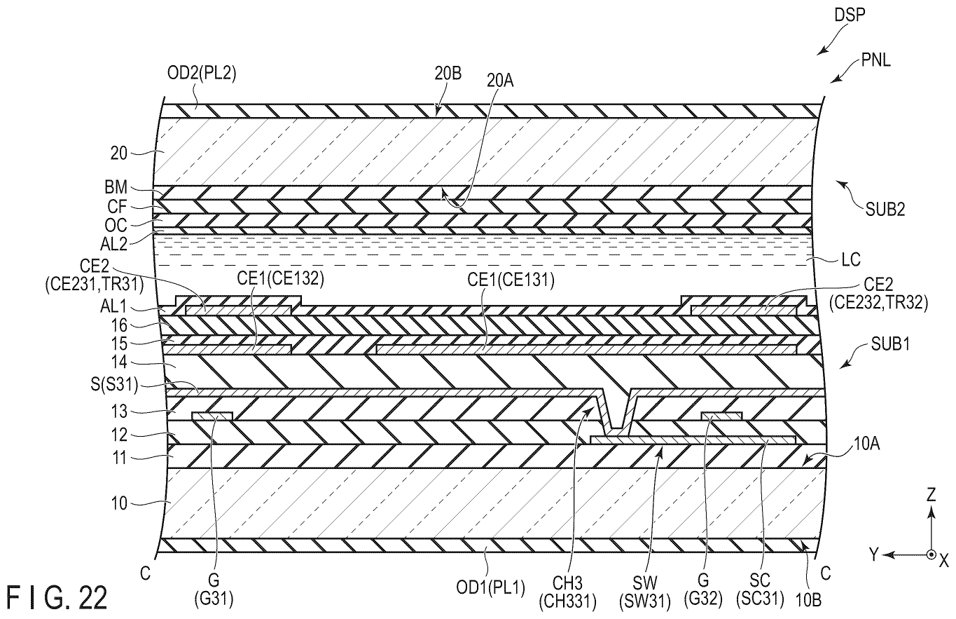

FIG. 22 is a cross-sectional view schematically showing a configuration example of the display device DSP cut along C-C in FIG. 21. Incidentally, FIG. 22 shows only a configuration necessary for description.

The first substrate SUB1 includes the common electrode CE1 (CE131 and CE132). In the example shown in FIG. 22, the common electrode CE1 includes the common electrodes CE131 and CE132. The common electrodes CE131 and CE132 are located on an insulating layer 14 and is in contact with the insulating layer 14. The common electrodes CE131 and CE132 are disposed at an interval in the second direction Y. The common electrode CE132 is disposed separated from the common electrode CE131 to the distal part side of the arrow in the second direction Y. In other words, the common electrode CE132 is disposed at an interval from the common electrode CE131 on the trunk portion TR31 side in the second direction Y.

Modified Example 4 as described above has the same effect as that of the first embodiment.

### Modified Example 5

A display device DSP according to Modified Example of the first embodiment is different from the display device DSP of Modified Example 4 described above in the configuration of a common electrode CE1.

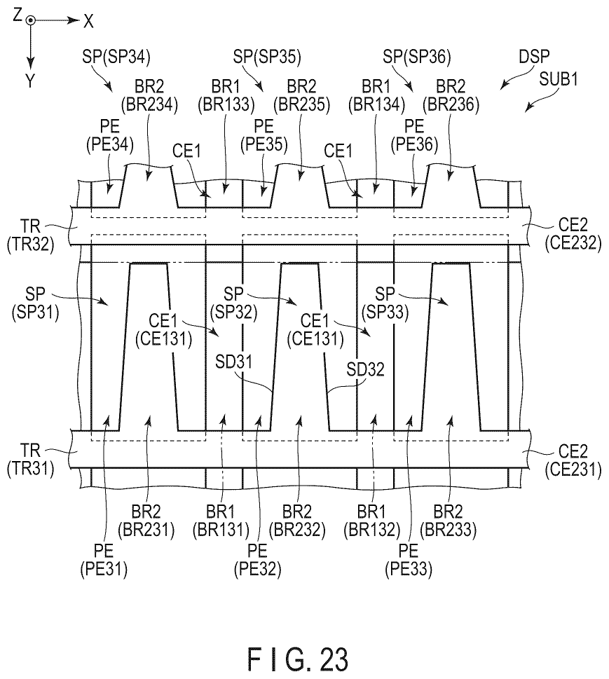

FIG. 23 is a plan view schematically showing a configuration example of a first substrate SUB1 according to the display device DSP of Modified Example FIG. 23 shows only a configuration necessary for description. The configuration shown in FIG. 23 corresponds to the configuration shown in FIG. 19.

In the example shown in FIG. 23, a common electrode CE131 is disposed separated from a trunk portion TR32 to the distal part side of the arrow in the second direction Y. In other words, the common electrode CE131 is disposed at an interval from the trunk portion TR32, on the distal part side of the arrow in the second direction Y. For example, the common electrode CE131 overlaps with the entire of sides SD31 and SD32.

A branch portion BR131 is exposed in an area separated from the trunk portion TR32 to the distal part side of the arrow in the second direction Y. In other words, the branch portion BR131 is located at an interval from the trunk portion TR32, on the distal part side of the arrow in the second direction Y. A branch portion BR132 is also exposed in an area separated from the trunk portion TR32 to the distal part side of the arrow in the second direction Y. In other words, the branch portion BR132 is also located at an interval from the trunk portion TR32, on the distal part side of the arrow in the second direction Y.

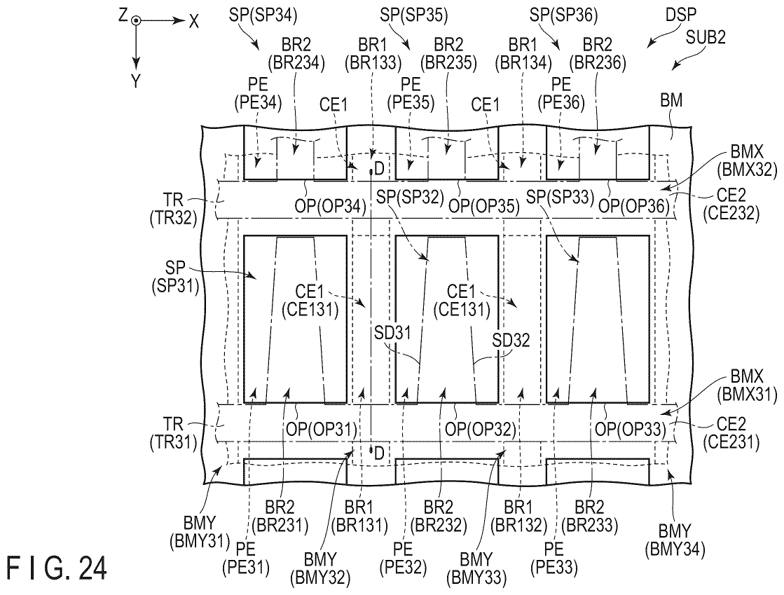

FIG. 24 is a plan view schematically showing a configuration example of a second substrate SUB2 according to Modified Example 5. Incidentally, FIG. 24 shows only a configuration necessary for description. The configuration shown in FIG. 24 corresponds to the configuration shown in FIG. 23.

In the example shown in FIG. 24, each of opening portions OP31 to OP33 overlaps with the common electrode CE131. Incidentally, a portion of each of the opening portions OP31 to OP33 may not overlap with the common electrode CE131. For example, a portion of each of the opening portions OP31 to OP33 on the opposite side to the distal part side of the arrow in the second direction Y may not overlap with the common electrode CE131.

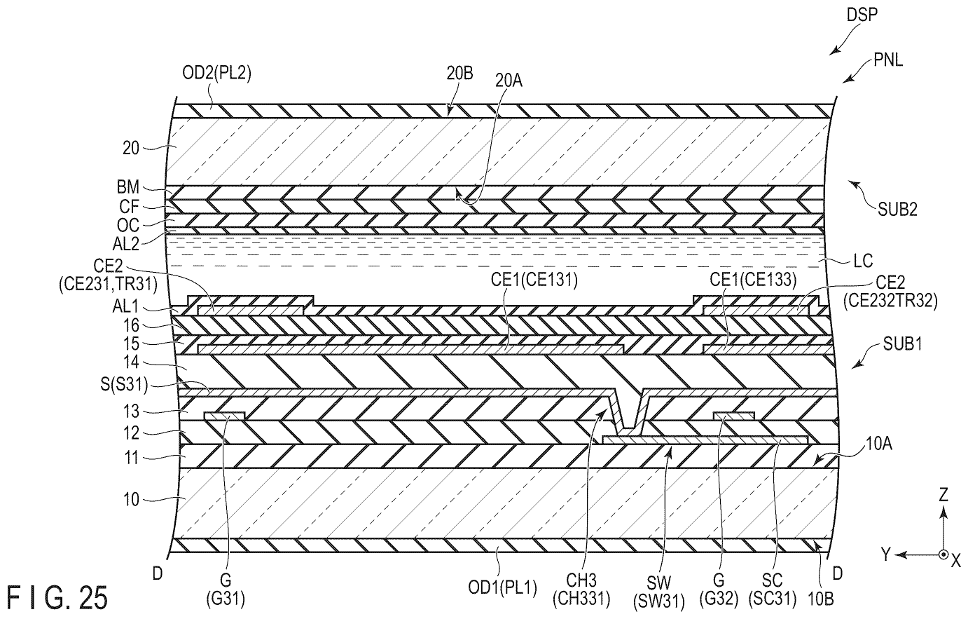

FIG. 25 is a cross-sectional view schematically showing a configuration example of the display device DSP cut along D-D in FIG. 24. Incidentally, FIG. 25 shows only a configuration necessary for description.

The first substrate SUB1 includes the common electrode CE1 (CE131 and CE133). In the example shown in FIG. 25, the common electrode CE1 includes the common electrodes CE131 and CE133. The common electrodes CE131 and CE133 are located on an insulating layer 14 and is in contact with the insulating layer 14. The common electrodes CE131 and CE133 are disposed at an interval in the second direction Y. The common electrode CE133 is disposed separated from the common electrode CE131 to the opposite side to the distal part side of the arrow in the second direction Y. In other words, the common electrode CE133 is separated from the common electrode CE131 to the trunk portion TR32 side in the second direction Y.

Modified Example 5 as described above has the same effect as that of the first embodiment.

### Modified Example 6

A display device DSP according to Modified example 6 of the first embodiment is different from the display device DSP of the first embodiment and Modified Example 1 to Modified Example 5 in the configurations of a first substrate SUB1 and a second substrate SUB2.

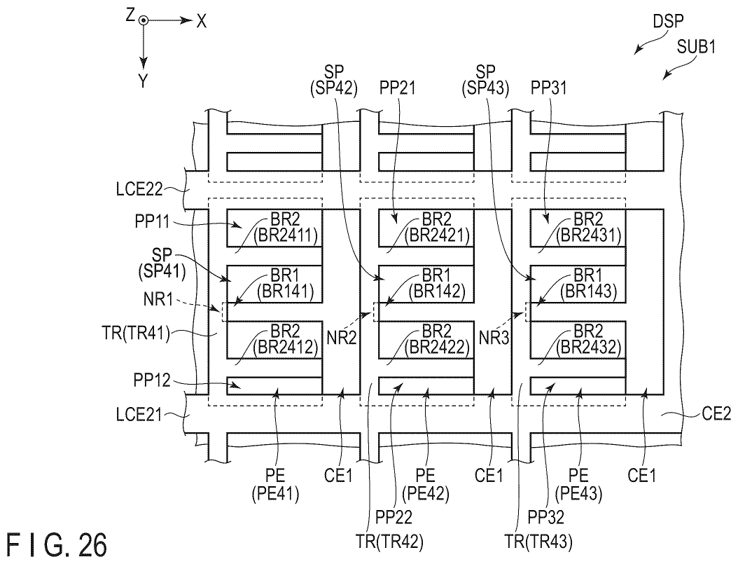

FIG. 26 is a plan view schematically showing a configuration example of the first substrate SUB1 according to the display device DSP of Modified Example 6. FIG. 26 shows only a configuration necessary for description.

In the example shown in FIG. 26, a pixel electrode PE includes pixel electrodes PE41, PE42, PE43, and others. The pixel electrodes PE41 to PE43 have slits extending in the first direction X. For example, the pixel electrodes PE41 to PE43 have slits at the central portion in the longitudinal width in the second direction Y. The pixel electrodes PE41, PE42, and PE43 are disposed at intervals toward the distal part side of the arrow in the first direction X in the mentioned order. In other words, the pixel electrodes PE41, PE42, and PE43 are arranged at intervals toward the distal part side of the arrow in the first direction X in the mentioned order. The sizes of the pixel electrodes PE41 to PE43 are the same. Incidentally, the sizes of the pixel electrodes PE41 to PE43 may be different from each other. The pixel electrode PE41 is disposed in a sub-pixel SP41. The pixel electrode PE42 is disposed in a sub-pixel SP42. The pixel electrode PE43 is disposed in a sub-pixel SP43.

The pixel electrode PE41 includes electrodes PP11 and PP12 and a narrow-width portion NR1. The electrodes PP11 and PP12 are formed in a rectangular shape. Incidentally, the electrodes PP11 and PP12 may be formed in a shape other than the rectangular shape. For example, the lateral widths of the electrodes PP11 and PP12 are the same. The lateral width of the narrow-width portion NR1 is smaller than the lateral width of the electrodes PP11 and PP12. The electrodes PP11 and PP12 are connected to each other via the narrow-width portion NR1. The narrow-width portion NR1 connects the end portions of the electrodes PP11 and PP12 to each other on the opposite side to the distal part side of the arrow in the first direction X. In other words, the narrow-width portion NR1 connects the end portions in the first direction X of the electrodes PP11 and PP12 to each other on the side of a trunk portion TR41 of a common electrode CE2 to be described later. In the pixel electrode PE41, a part other than the narrow-width portion NR1 between the electrode PP11 and the electrode PP12 corresponds to a slit. In other words, in the pixel electrode PE41, the slit is formed on the distal part side of the arrow in the first direction X from the narrow-width portion NR1.

The pixel electrode PE42 includes electrodes PP21 and PP22 and a narrow-width portion NR2. The pixel electrodes PP21 and PP22 are formed in a rectangular shape. Incidentally, the electrodes PP21 and PP22 may be formed in a shape other than the rectangular shape. For example, the lateral widths of the electrodes PP21 and PP22 are the same. The lateral width of the narrow-width portion NR2 is smaller than the lateral width of the electrodes PP21 and PP22. The electrodes PP21 and PP22 are connected to each other via the narrow-width portion NR2. The narrow-width portion NR2 connects the end portions of the electrodes PP21 and PP22 to each other on the opposite side to the distal part side of the arrow in the first direction X. In other words, the narrow-width portion NR2 connects the end portions in the first direction X of the electrodes PP21 and PP22 to each other on the side of the trunk portion TR42 of the common electrode CE2 to be described later. In the pixel electrode PE42, a part other than the narrow-width portion NR2 between the electrode PP21 and the electrode PP22 corresponds to a slit. In other words, in the pixel electrode PE42, the slit is formed on the distal part side of the arrow in the first direction X from the narrow-width portion NR2.

The pixel electrode PE43 includes electrodes PP31 and PP32 and a narrow-width portion NR3. The pixel electrodes PP31 and PP32 are formed in a rectangular shape. Incidentally, the electrodes PP31 and PP32 may be formed in a shape other than the rectangular shape. For example, the lateral widths of the electrodes PP31 and PP32 are the same. The lateral width of the narrow-width portion NR3 is smaller than the lateral width of the electrodes PP31 and PP32. The electrodes PP31 and PP32 are connected to each other via the narrow-width portion NR3. The narrow-width portion NR3 connects the end portions of the electrodes PP31 and PP32 to each other on the opposite side to the distal part side of the arrow in the first direction X. In other words, the narrow-width portion NR3 connects the end portions in the first direction X of the electrodes PP31 and PP32 to each other on the side of the trunk portion TR43 of the common electrode CE2 to be described later. In the pixel electrode PE43, a part other than the narrow-width portion NR3 between the electrode PP31 and the electrode PP32 corresponds to a slit. In other words, in the pixel electrode PE43, the slit is formed on the distal part side of the arrow in the first direction X from the narrow-width portion NR3.

In the example shown in FIG. 26, the common electrode CE2 includes a common electrode LCE21, a common electrode LCE22, the trunk portions TR41, TR42, and TR43, and branch portions BR2411, BR2412, BR2421, BR2422, BR2431, and BR2432. The common electrodes LCE21 and LCE22 extend in the first direction X. The common electrodes LCE21 and LCE22 are arranged at an interval toward the opposite side to the distal part side of the arrow in the second direction Y in the mentioned order. The common electrode LCE21 overlaps with the end portions of the pixel electrodes PE41, PE42, and PE43 on the distal part side of the arrow in the second direction Y. The common electrode LCE22 overlaps with the end portions of the pixel electrodes PE41, PE42, and PE43 on the opposite side to the distal part side of the arrow in the second direction Y.

The trunk portions TR41, TR42, and TR43 extend in the second direction Y. The trunk portions TR41, TR42, and TR43 are arranged at intervals toward the distal part side of the arrow in the first direction X in the mentioned order. The trunk portions TR41, TR42, and TR43 are connected to at least one of the common electrodes LCE21 and LCE22. Incidentally, the trunk portions TR41 to TR43 do not need to be connected to the common electrodes LCE21 and LCE22. The trunk portion TR41 is disposed in the sub-pixel SP41. The trunk portion TR42 is disposed in the sub-pixel SP42. The trunk portion TR43 is disposed in the sub-pixel SP43.

The branch portions BR2411, BR2412, BR2421, BR2422, BR2431, and BR2432 extend in the first direction X. The branch portions BR2411, BR2412, BR2421, BR2422, BR2431, and BR2432 are formed in, for example, a rectangular shape. Incidentally, the branch portions BR2411, BR2412, BR2421, BR2422, BR2431, and BR2432 may be formed in a shape other than the rectangular shape. The lateral widths of the branch portions BR2411, BR2412, BR2421, BR2422, BR2431, and BR2432 are the same. Incidentally, the lateral widths of the branch portions BR2411, BR2412, BR2421, BR2422, BR2431, and BR2432 may be different from each other.

The branch portions BR2411 and BR2412 are connected to the trunk portion TR41. The branch portions BR2411 and BR2412 extend from the trunk portion TR41 to the distal part side of the arrow in the first direction X. For example, the branch portions BR2411 and BR2412 are parallel to each other. Incidentally, the branch portions BR2411 and BR2412 may not be parallel to each other. The distal portions of the branch portions BR2411 and BR2412 on the distal part side of the arrow in the first direction X may be separated from the trunk portion TR42. Incidentally, the distal portions of the branch portions BR2411 and BR2412 on the distal part side of the arrow in the first direction X may be in contact with the trunk portion TR42. The branch portions BR2411 and BR2412 are arranged at an interval in the second direction Y in the mentioned order. The branch portions BR2411 and BR2412 are disposed in the sub-pixel SP41. The branch portion BR2411 overlaps with the electrode PP11. The branch portion BR2412 overlaps with the electrode PP12.

The branch portions BR2421 and BR2422 are connected to the trunk portion TR42. The branch portions BR2421 and BR2422 extend from the trunk portion TR42 to the distal part side of the arrow in the first direction X. For example, the branch portions BR2421 and BR2422 are parallel to each other. Incidentally, the branch portions BR2421 and BR2422 may not be parallel to each other. The distal portions of the branch portions BR2421 and BR2422 on the distal part side of the arrow in the first direction X are separated from the trunk portion TR43. Incidentally, the distal portions of the branch portions BR2421 and BR2422 on the distal part side of the arrow in the first direction X may be in contact with the trunk portion TR43. The branch portions BR2421 and BR2422 are arranged at an interval in the second direction Y in the mentioned order. The branch portions BR2421 and BR2422 are disposed in the sub-pixel SP42. The branch portion BR2421 overlaps with the electrode PP21. The branch portion BR2422 overlaps with the electrode PP22.

The branch portions BR2431 and BR2432 are connected to the trunk portion TR43. The branch portions BR2431 and BR2432 extend from the trunk portion TR43 to the distal part side of the arrow in the first direction X. For example, the branch portions BR2431 and BR2432 are parallel to each other. Incidentally, the branch portions BR2431 and BR2432 may not be parallel to each other. The branch portions BR2431 and BR2432 are arranged at an interval in the second direction Y in the mentioned order. The branch portions BR2431 and BR2432 are disposed in the sub-pixel SP43. The branch portion BR2431 overlaps with the electrode PP31. The branch portion BR2432 overlaps with the electrode PP32.

In the example shown in FIG. 26, a common electrode CE1 includes branch portions BR141, BR142, and BR143. The branch portions BR141, BR142, and BR143 are arranged at intervals toward the distal part side of the arrow in the first direction X in the mentioned order. The branch portions BR141 to BR143 extend in the first direction X. The branch portions BR141 to BR143 are formed in a rectangular shape. Incidentally, the branch portions BR141 to BR143 may be formed in a shape other than the rectangular shape. In addition, the shapes of the branch portions BR141 to BR143 may be the same as or different from the shapes of the branch portions BR2411, BR2412, BR2421, BR2422, BR2431, and BR2432. The lateral widths of the branch portions BR141 to BR143 are the same. Incidentally, the lateral widths of the branch portions BR141 to BR143 may be different from each other.

The branch portion BR141 is disposed in the sub-pixel SP41. The branch portion BR141 is exposed from between the electrodes PP11 and PP12 and the narrow-width portion NR1. In other words, the branch portion BR141 corresponds to the common electrode CE1 exposed from the slit of the pixel electrode PE41. The branch portion BR141 extends from the trunk portion TR41 to the distal part side of the arrow in the first direction X. The branch portion BR141 is disposed between the branch portions BR2411 and BR2412 in the second direction Y. In other words, in the sub-pixel SP41, the branch portion BR2411, the branch portion BR141, and the branch portion BR2412 are disposed at intervals toward the distal part side of the arrow in the second direction Y in the mentioned order.

The branch portion BR142 is disposed in the sub-pixel SP42. The branch portion BR142 is exposed from between the electrodes PP21 and PP22 and the narrow-width portion NR2. In other words, the branch portion BR142 corresponds to the common electrode CE1 exposed from the slit of the pixel electrode PE42. The branch portion BR142 extends from the trunk portion TR42 to the distal part side of the arrow in the first direction X. The branch portion BR142 is disposed between the branch portions BR2421 and BR2422 in the second direction Y. In other words, in the sub-pixel SP42, the branch portion BR2421, the branch portion BR142, and the branch portion BR2422 are disposed at intervals toward the distal part side of the arrow in the second direction Y in the mentioned order.

The branch portion BR143 is disposed in the sub-pixel SP43. The branch portion BR143 is exposed from between the electrodes PP31 and PP32 and the narrow-width portion NR3. In other words, the branch portion BR143 corresponds to the common electrode CE1 exposed from the slit of the pixel electrode PE43. The branch portion BR143 extends from the trunk portion TR43 to the distal part side of the arrow in the first direction X. The branch portion BR143 is disposed between the branch portions BR2431 and BR2432 in the second direction Y. In other words, in the sub-pixel SP43, the branch portion BR2431, the branch portion BR143, and the branch portion BR2432 are disposed at intervals toward the distal part side of the arrow in the second direction Y in the mentioned order.

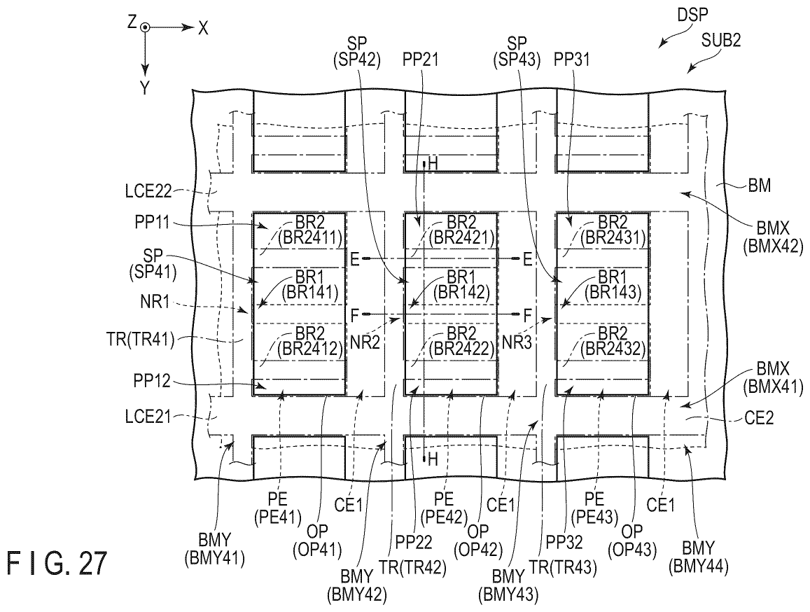

FIG. 27 is a plan view schematically showing a configuration example of the second substrate SUB2 according to Modified Example 6. Incidentally, FIG. 27 shows only a configuration necessary for description. The configuration shown in FIG. 27 corresponds to the configuration shown in FIG. 26.

In the example shown in FIG. 27, a light-shielding layer BM includes longitudinal parts BMY41, BMY42, BMY43, and BMY44, and lateral parts BMX41 and BMX42. The longitudinal parts BMY41, BMY42, BMY43, and BMY44 have substantially the same lateral width, and are arranged at regular intervals in the first direction X. The longitudinal part BMY41 extends in the second direction Y and overlaps with the trunk portion TR41. The longitudinal part BMY42 extends in the second direction Y and overlaps with the trunk portion TR42. The longitudinal part BMY43 extends in the second direction Y and overlaps with the trunk portion TR43. The longitudinal part BMY44 extends in the second direction Y and located on the distal part side of the arrow in the first direction X with respect to the pixel electrode PE43.

The lateral parts BMX41 and BMX42 have substantially the same longitudinal width, and are arranged at a regular interval in the second direction Y in the mentioned order. The lateral part BMX41 extends along the common electrode LCE21 in the first direction X and overlaps with the common electrode LCE21. The lateral part BMX42 extends along the common electrode LCE22 in the first direction X and overlaps with the common electrode LCE22.

In the example shown in FIG. 27, the light-shielding layer BM includes opening portions OP41, OP42, OP43, and others. The opening portions OP41, OP42, and OP43 are arranged in a matrix. The opening portions OP41, OP42, and OP43 are arranged at regular intervals in the first direction X in the mentioned order.

The opening portion OP41 is defined by the longitudinal parts BMY41 and BMY42 and the lateral parts BMX41 and BMX42. The opening portion OP41 is disposed in the sub-pixel SP41. The opening portion OP41 overlaps with the branch portion BR141, the branch portions BR2411 and BR2412, the pixel electrode PE41, and others. The opening portion OP42 is defined by the longitudinal parts BMY42 and BMY43 and the lateral parts BMX41 and BMX42. The opening portion OP42 is disposed in the sub-pixel SP42. The opening portion OP42 overlaps with the branch portion BR142, the branch portions BR2421 and BR2422, the pixel electrode PE42, and others. The opening portion OP43 is defined by the longitudinal parts BMY43 and BMY44 and the lateral parts BMX41 and BMX42. The opening portion OP43 is disposed in the sub-pixel SP43. The opening portion OP43 overlaps with the branch portion BR143, the branch portions BR2431 and BR2432, the pixel electrode PE43, and others.

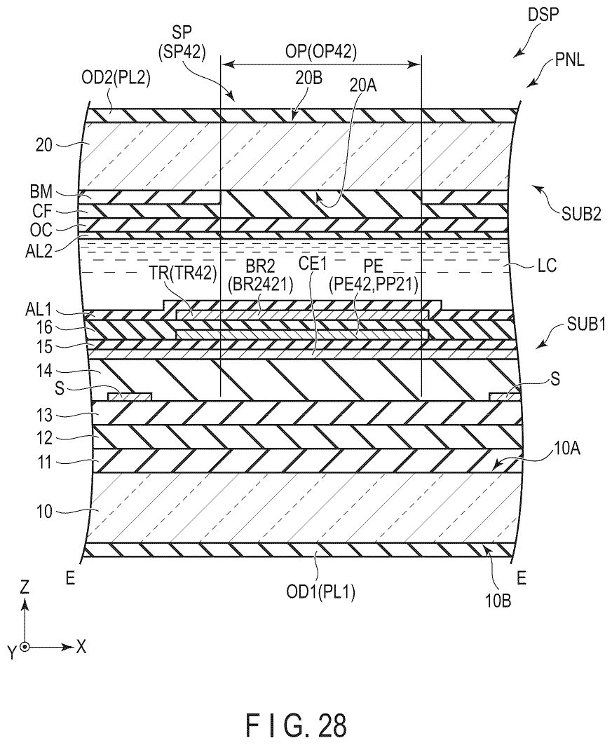

FIG. 28 is a cross-sectional view schematically showing a configuration example of the display device DSP cut along E-E in FIG. 27. Incidentally, FIG. 28 shows only a configuration necessary for description.

The electrode PP21 of the pixel electrode PE42 is located on an insulating layer 15 and is in contact with the insulating layer 15. An insulating layer 16 is located on the insulating layer 15 and the electrode PP21, and covers the insulating layer 15 and the electrode PP21. The lateral width of the electrode PP21 is substantially the same as the sum of the lateral width of the branch portion BR2421 and the lateral width of the trunk portion TR42. Incidentally, the lateral width of the electrode PP21 may be smaller or larger than the sum of the lateral width of the branch portion BR2421 and the lateral width of the trunk portion TR42. The electrode PP21 overlaps with the opening portion OP42.

The trunk portion TR42 and the branch portion BR2421 are located on the insulating layer 16 and is in contact with the insulating layer 16. The trunk portion TR42 and the branch portion BR2421 are continuously disposed toward the distal part side of the arrow in the first direction X. The trunk portion TR42 and the branch portion BR2421 are connected to each other. The trunk portion TR42 does not overlap with the opening portion OP42. Incidentally, the trunk portion TR42 may overlap with the opening portion OP42. The branch portion BR2421 extends from the trunk portion TR42 to the distal part side of the arrow in the first direction X. The branch portion BR2421 overlaps with the opening portion OP42.

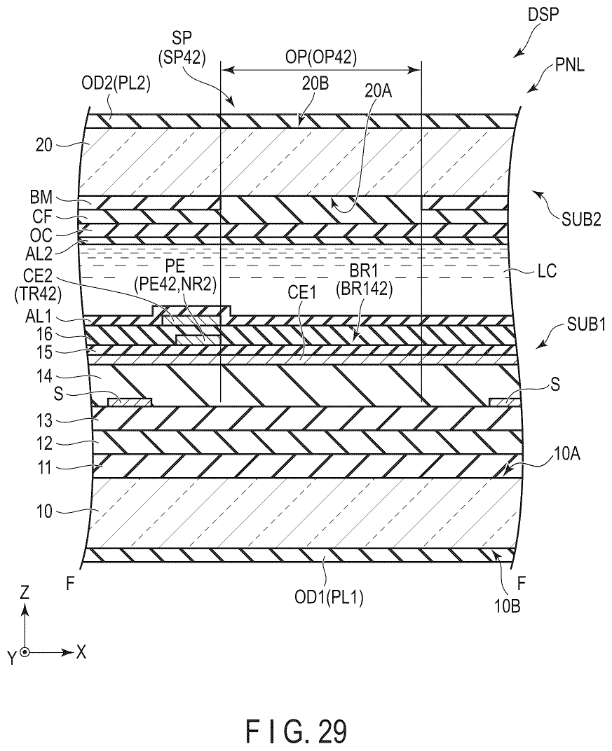

FIG. 29 is a cross-sectional view schematically showing a configuration example of the display device DSP cut along F-F in FIG. 27. Incidentally, FIG. 29 shows only a configuration necessary for description.

The branch portion BR142 corresponds to a part overlapping with the opening portion OP42 of the common electrode CE1.

The narrow-width portion NR2 of the pixel electrode PE42 is located on the insulating layer 15 and is in contact with the insulating layer 15. The insulating layer 16 is located on the insulating layer 15 and the narrow-width portion NR2, and covers the insulating layer 15 and the narrow-width portion NR2. For example, the narrow-width portion NR2 does not overlap with the opening portion OP42. Incidentally, the narrow-width portion NR2 may overlap with the opening portion OP42. The narrow-width portion NR2 does not overlap with the branch portion BR142. The trunk portion TR42 overlaps with the narrow-width portion NR2. The trunk portion TR42 does not overlap with the branch portion BR142.

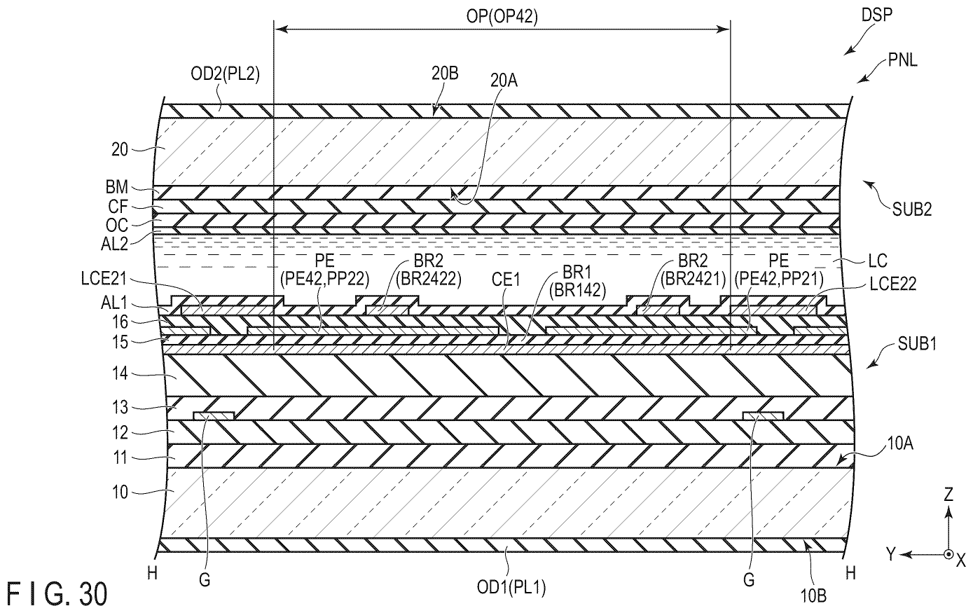

FIG. 30 is a cross-sectional view schematically showing a configuration example of the display device DSP cut along H-H in FIG. 27. Incidentally, FIG. 30 shows only a configuration necessary for description.

The electrodes PP21 and PP22 of the pixel electrode PE42 is located on the insulating layer 15 and is in contact with the insulating layer 15. The insulating layer 16 is located on the insulating layer and the electrodes PP21 and PP22, and covers the insulating layer 15 and the electrodes PP21 and PP22. The electrodes PP21 and PP22 are separated from each other with an interval (slit) in the second direction Y. The branch portion BR142 of the common electrode CE1 is exposed from between the electrodes PP21 and PP22.

The common electrode LCE21, the branch portion BR2421, the branch portion BR2422, and the common electrode LCE22 are located on the insulating layer 16, and are in contact with the insulating layer 16. The common electrode LCE21, the branch portion BR2421, the branch portion BR2422 and the common electrode LCE22 are disposed at intervals toward the opposite side to the distal part side of the arrow in the second direction Y in the mentioned order. For example, the common electrodes LCE21 and LCE22 do not overlap with the opening portion OP42. Incidentally, the common electrodes LCE21 and LCE22 may overlap with the opening portion OP42. The branch portion BR2421 and the branch portion BR2422 overlap with the opening portion OP42. The branch portion BR2421 overlaps with the electrode PP21, and the branch portion BR2422 overlaps with the electrode PP22. The branch portions BR2421 and BR2422 do not overlap with the branch portion BR142. The branch portion BR2421, the branch portion BR142, and the branch portion BR2422 are disposed at intervals in the second direction Y in the mentioned order.

Modified Example 6 as described above has the same effect as that of the first embodiment.

### Modified Example 7

A display device DSP according to Modified Example 7 of the first embodiment is different from the display device DSP of Modified Example 6 described above in the configuration of a first substrate SUB1.

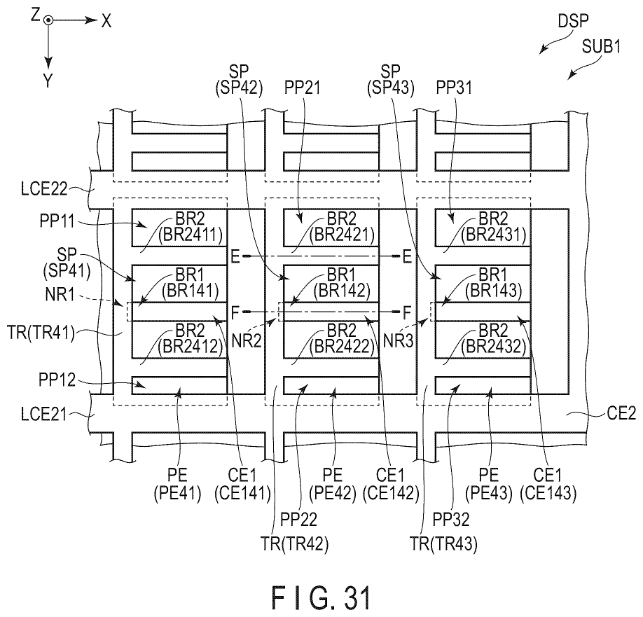

FIG. 31 is a plan view schematically showing a configuration example of the first substrate SUB1 according to the display device DSP of Modified Example 7. FIG. 31 shows only a configuration necessary for description.

In the example shown in FIG. 31, a common electrode CE1 includes common electrodes CE141, CE142, and CE143. The common electrodes CE141, CE142, and CE143 are arranged at intervals toward the distal part side of the arrow in the first direction in the mentioned order. The common electrodes CE141 to CE143 extend in the second direction Y.

The common electrode CE141 is disposed in a sub-pixel SP41. The common electrode CE141 is disposed separated from a trunk portion TR42 to the opposite side to the distal part side of the arrow in the first direction. For example, the end portion of the common electrode CE141 in the first direction X and the end portions of branch portions BR2411 and BR2412 in the first direction X are aligned in the first direction X. In other words, the end portion of the common electrode CE141 in the first direction X and the end portions of the branch portions BR2411 and BR2412 in the first direction X are located at the same position in the first direction X. The common electrode CE141 overlaps with a pixel electrode PE41. In addition, the common electrode CE141 overlaps with a trunk portion TR41 and the branch portions BR2411 and BR2412. The common electrode CE141 includes a branch portion BR141. The branch portion BR141 extends in the first direction X. The branch portion BR141 is formed in a rectangular shape. Incidentally, the branch portion BR141 may be formed in a shape other than the rectangular shape. The lateral width of the branch portion BR141 is, for example, the same as the lateral width of the branch portions BR2411 and BR2412. Incidentally, the lateral width of the branch portion BR141 may be, for example, different from the lateral width of the branch portions BR2411 and BR2412.

The common electrode CE142 is disposed in a sub-pixel SP42. The common electrode CE142 is disposed separated from a trunk portion TR43 to the opposite side to the distal part side of the arrow in the first direction. For example, the end portion of the common electrode CE142 in the first direction X and the end portions of branch portions BR2421 and BR2422 in the first direction X are aligned in the first direction X. In other words, the end portion of the common electrode CE142 in the first direction X and the end portions of the branch portions BR2421 and BR2422 in the first direction X are located at the same position in the first direction X. The common electrode CE142 overlaps with a pixel electrode PE42. In addition, the common electrode CE142 overlaps with the trunk portion TR42 and the branch portions BR2421 and BR2422. The common electrode CE142 includes a branch portion BR142. The branch portion BR142 extends in the first direction X. The branch portion BR142 is formed in a rectangular shape. Incidentally, the branch portion BR142 may be formed in a shape other than the rectangular shape. The lateral width of the branch portion BR142 is, for example, the same as the lateral width of the branch portions BR2421 and BR2422. Incidentally, the lateral width of the branch portion BR142 may be, for example, different from the lateral width of the branch portions BR2421 and BR2422. In addition, the lateral width of the branch portion BR142 is, for example, the same as the lateral width of the branch portions BR141. Incidentally, the lateral width of the branch portion BR142 may be different from the lateral width of the branch portion BR141.

The common electrode CE143 is disposed in a sub-pixel SP43. For example, the end portion of the common electrode CE143 in the first direction X and the end portions of branch portions BR2431 and BR2432 in the first direction X are aligned in the first direction X. In other words, the end portion of the common electrode CE143 in the first direction X and the end portions of the branch portions BR2431 and BR2432 in the first direction X are located at the same position in the first direction X. The common electrode CE143 overlaps with a pixel electrode PE43. In addition, the common electrode CE143 overlaps with the trunk portion TR43 and the branch portions BR2431 and BR2432. The common electrode CE143 includes a branch portion BR143. The branch portion BR143 extends in the first direction X. The branch portion BR143 is formed in a rectangular shape. Incidentally, the branch portion BR143 may be formed in a shape other than the rectangular shape. The lateral width of the branch portion BR143 is, for example, the same as the lateral width of the branch portions BR2431 and BR2432. Incidentally, the lateral width of the branch portion BR143 may be, for example, different from the lateral width of the branch portions BR2431 and BR2432. In addition, the lateral width of the branch portion BR143 is, for example, the same as the lateral width of the branch portions BR141 and BR142. Incidentally, the lateral width of the branch portion BR143 may be, for example, different from the lateral width of the branch portions BR141 and BR142.

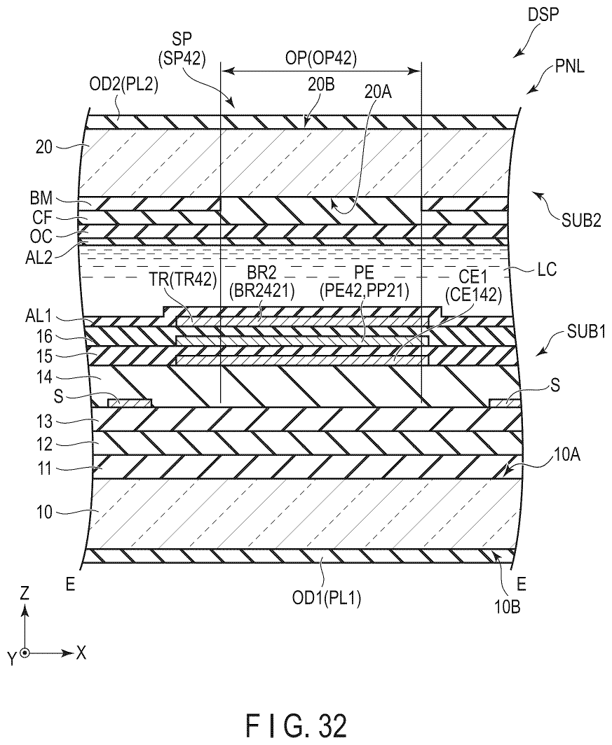

FIG. 32 is a cross-sectional view schematically showing a configuration example of the display device DSP cut along E-E in FIG. 31. Incidentally, FIG. 32 shows only a configuration necessary for description.

The common electrode CE142 is located on an insulating layer 14 and is in contact with the insulating layer 14. An insulating layer 15 is located on the insulating layer 14 and the common electrode CE142, and covers the insulating layer 14 and the common electrode CE142. The lateral width of the common electrode CE142 is, for example, the same as the sum of the lateral widths of the trunk portion TR42 and the branch portion BR2421. Incidentally, the lateral width of the common electrode CE142 may be, for example, different from the sum of the lateral widths of the trunk portion TR42 and the branch portion BR2421. The lateral width of the common electrode CE142 is, for example, the same as the lateral width of the pixel electrode PE42. Incidentally, the lateral width of the common electrode CE142 may be, for example, different from the lateral width of the pixel electrode PE42. The common electrode CE142 overlaps with an opening portion OP42. The common electrode CE142 overlaps with the pixel electrode PE42. The common electrode CE142 overlaps with the branch portion BR2421.

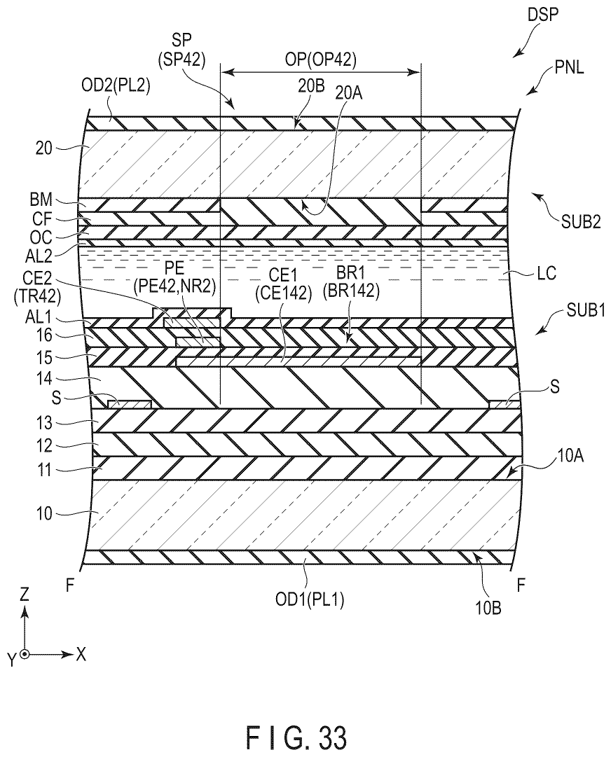

FIG. 33 is a cross-sectional view schematically showing a configuration example of the display device DSP cut along F-F in FIG. 31. Incidentally, FIG. 33 shows only main portions of the display device DSP.

In addition, the lateral width of the branch portion BR142 is, for example, the same as the lateral width of the opening portion OP42. Incidentally, the lateral width of the branch portion BR142 may be different from the lateral width of the opening portion OP42. The common electrode CE142 overlaps with a narrow-width portion NR2. Incidentally, the common electrode CE142 may not overlap with the narrow-width portion NR2.

Modified Example 7 as described above has the same effect as that of the first embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate;
a second substrate opposed to the first substrate; and
a liquid crystal layer consisting of liquid crystal molecules located between the first substrate and the second substrate, wherein
the first substrate includes a first electrode, a first pixel electrode, a second pixel electrode disposed at an interval in a first direction from the first pixel electrode, and a second electrode,
the second substrate includes a light-shielding layer,
the first pixel electrode and the second pixel electrode overlap with the first electrode,
the first electrode includes a first branch portion that is exposed from between the first pixel electrode and the second pixel electrode and extends in a second direction intersecting the first direction,
the second electrode includes a first trunk portion extending in the first direction, a second branch portion with a first long edge and a second long edge extending in the second direction from the first trunk portion, and a second trunk portion disposed at an interval in the second direction from the first trunk portion and extending in the first direction,
the second branch portion overlaps with the first pixel electrode,
the light-shielding layer includes a first opening portion, a second opening portion provided at an interval in the first direction from the first opening portion, and a light-shielding portion located between the first opening portion and the second opening portion,
the first opening portion overlaps with the second branch portion,
the light-shielding portion overlaps with the first branch portion, and
when a voltage is applied between the first pixel electrodes and the second electrode, the liquid crystal molecules near the first long edge of the second branch portion and the liquid crystal molecules near the second long edge of the second branch portion rotate in opposite directions.

2. The display device according to claim 1, wherein
the first substrate includes a first insulating layer, a second insulating layer located on the first insulating layer, and a third insulating layer located on the second insulating layer,
the first electrode is located between the first insulating layer and the second insulating layer,
the first pixel electrode and the second pixel electrode are located between the second insulating layer and the third insulating layer, and
the second electrode is located on the third insulating layer.

3. The display device according to claim 2, wherein
the second branch portion has a distal portion being separated from the second trunk portion, the distal portion being located on a side of the second trunk portion in the second direction.

4. The display device according to claim 2, wherein
the second branch portion has a distal portion being in contact with the second trunk portion, the distal portion being located on a side of the second trunk portion in the second direction.

5. The display device according to claim 1, wherein
the second branch portion has two sides that are opposed to each other in the first direction and parallel to each other.

6. The display device according to claim 5, wherein
the second branch portion is formed in a rectangular shape.

7. The display device according to claim 1, wherein
the second branch portion has two sides that are opposed to each other in the first direction and not parallel to each other.

8. The display device according to claim 7, wherein
the second branch portion is formed in a trapezoidal shape tapered in the first direction.

9. The display device according to claim 5, wherein
the first branch portion is formed in a rectangular shape.

10. The display device according to claim 1, wherein
the first opening portion has a width in the first direction equal to or less than a width of the first pixel electrode in the first direction.

11. The display device according to claim 1, wherein the first branch portion has a distal portion that is separated from the second trunk portion, the distal portion being located on a side of the second trunk portion in the second direction.

12. The display device according to claim 1, wherein
the first branch portion has a distal portion that is separated from the first trunk portion, the distal portion being located on a side of the first trunk portion in the second direction.

13. The display device according to claim 1, wherein
the first electrode and the second electrode have electric potentials that are equal to each other.

14. The display device according to claim 13, wherein
the first pixel electrode and the second pixel electrode have electric potentials different from the electric potentials of the first electrode and the second electrode.

15. A display device comprising:
a first substrate;
a second substrate opposed to the first substrate; and
a liquid crystal layer located between the first substrate and the second substrate, wherein
the first substrate includes a first electrode, a first pixel electrode, a second pixel electrode disposed at an interval in a first direction from the first pixel electrode, and a second electrode,
the second substrate includes a light-shielding layer,
the first pixel electrode and the second pixel electrode overlap with the first electrode,
the first electrode includes a first branch portion that is exposed from between the first pixel electrode and the second pixel electrode and extends in a second direction intersecting the first direction,
the second electrode includes a second branch portion extending in the second direction,
the second branch portion overlaps with the first pixel electrode,
the light-shielding layer includes a first opening portion, a second opening portion provided at an interval in the first direction from the first opening portion, and a light-shielding portion located between the first opening portion and the second opening portion,
the first opening portion overlaps with the second branch portion, and
the light-shielding portion overlaps with the first branch portion.

16. A display device comprising:
a first substrate;
a second substrate opposed to the first substrate; and
a liquid crystal layer located between the first substrate and the second substrate, wherein
the first substrate includes a first electrode, a first pixel electrode, and a second electrode,
the second substrate includes a light-shielding layer,
the first pixel electrode overlaps with the first electrode,
the first pixel electrode includes a first portion, a second portion disposed separated in the first direction from the first portion, and a slit extending between the first portion and the second portion in a second direction intersecting the first direction,
the first electrode includes a first branch portion that is exposed from the slit and extends in the second direction,
the second electrode includes a first trunk portion extending in the first direction, a second branch portion extending in the second direction from the first trunk portion, a third branch portion disposed at an interval in the first direction from the second branch portion and extending in the second direction from the first trunk portion, and a second trunk portion disposed at an interval in the second direction from the first trunk portion and extending in the first direction,
the second branch portion overlaps with the first portion,
the third branch portion overlaps with the second portion,
the light-shielding layer includes an opening portion, and
the opening portion overlaps with the first branch portion, the second branch portion, and the third branch portion.
